(19) United States
(12) Patent Application Publication
(10) Pub. No.: US 2002/0004881 A1
(43) Pub. Date: Jan. 10, 2002

(54) Data transfer apparatus and data transfer method

(75) Inventors: Yukio Iijima, Ikoma-shi (JP); Thoru Kakiage, Neyagawa-shi (JP); Toshinori Maeda, Neyagawa-shi (JP)

Correspondence Address: PARKHURST & WENDEL, L.L.P., 1421 Prince Street, Suite 210, Alexandria, VA, 22314-2805, US

(73) Assignee: MATSUSHITA ELECTRIC INDUSTRIAL CO., LTD.

(21) Appl. No.: 09/843,140

(22) Filed: Apr. 27, 2001

(30) Foreign Application Priority Data
Apr. 28, 2000 (JP) 2000-129035

(51) Int. Cl. G06F 12/00

(52) U.S. Cl. 711/105; 711/218; 711/167

(57) ABSTRACT

A data transfer apparatus is provided with a SRAM, in which storage positions are specified on the basis of the number of times synchronous data is transferred, for holding data in the specified storage positions; and a SRAM control unit having a plurality of counters, for controlling data storage and data reading in/from the SRAM, by generating storage addresses indicating the storage positions on the SRAM 6, and generating read addresses for reading data from the storage positions. Therefore, the number of accesses to a DRAM is reduced, whereby the system performance is improved. Further, the operating clock frequency of the apparatus can be increased without increasing the operating clock of the DRAM.

### FIELD OF THE INVENTION

The present invention relates to a data transfer apparatus and a data transfer method and, more particularly, to those using a temporary storage and transferring one piece of data to various kinds of devices that are operated with asynchronous clocks.

### BACKGROUND OF THE INVENTION

Conventionally, for efficient data recording or transmission, data are subjected to a coding process according to a predetermined method before being recorded or transmitted, and recorded or transmitted data are subjected to a decoding process, which is the reverse of the coding process, before being utilized. Further, in order to check and correct errors in data caused by noise or the like during data reading/writing or transmission, redundant codes called parity bits are added to the data when the data are recorded or transmitted, and ECC (Error Checking and Correction) is carried out during the decoding process, whereby the reliability is increased.

In arithmetic processing such as ECC or the like, required data are stored in a temporary storage means and subjected to the arithmetic processing in the storage means. It is general to employ a DRAM (Dynamic Random Access Memory) as the temporary storage means because the DRAM is inexpensive. However, since the DRAM requires many cycles for data access and a long access time, it is important to reduce the number of accesses to the DRAM for improved system performance.

Further, asynchronous processing is required for data transmission between a recording medium and a DRAM as a temporary data storage means, and speed-up of this asynchronous processing is also important for improved system performance.

FIG. 16 is a block diagram illustrating the construction of a conventional data transfer apparatus.

In FIG. 16, the data transfer apparatus comprises a data disk 1, a data binarization circuit 2, a data PLL circuit 3, a data demodulation circuit 4, an FIFO buffer 5, a clock synchronization circuit/data interpolation circuit 20, a DRAM access arbitration circuit 7, a DRAM control circuit 8, a DRAM 9, and an error correction circuit 10.

In the conventional data transfer apparatus, data read from the recording medium 1 is demodulated by the data demodulation circuit 4, and the demodulated data S4 so obtained is temporarily stored in the FIFO buffer 5 based on FIFO (first-in first-out). Then, the data stored in the FIFO buffer 5 is read out, subjected to asynchronous data passing between the clock of the data disk 1 and the operating clock of the DRAM 9 by the clock synchronization circuit 20, stored in the DRAM 9, subjected to ECC by the error correction circuit 10, and transferred to the subsequent circuit.

Further, in the conventional data transfer apparatus, in order to deal with the case where some of the input data are missing because the data cannot be correctly read due to flaws on the data disk 1 or the like, data interpolation is carried out by the data interpolation circuit 20 and the FIFO buffer 5. For example, when using a data sync byte that is inserted in the input data for every predetermined amount of data, the amount of data between the data sync bytes included in the data stored in the FIFO buffer 5 is checked by detecting the data sync bytes. When the amount of data is lower than a predetermined value, dummy data are generated and added to secure the predetermined amount of data between the data sync bytes, thereby improving the efficiency of ECC.

In recent years, as the data reading speed from a recording medium is increased, the data input speed from the recording medium to a processing unit is increased. However, a data transfer apparatus that can transfer data without increasing the frequency of system clock is demanded with regard to power consumption.

In the conventional data transfer apparatus, however, although the input data are temporarily stored in the FIFO buffer 5, the stored data are sequentially read and stored in the DRAM 9, and error correction is performed using the data stored in the DRAM 9. Therefore, the number of accesses to the DRAM 9 cannot be reduced, and the clock frequency of the DRAM 9 and the DRAM control circuit 8 must be increased as the clock frequency of the data disk 1 is increased.

Furthermore, in the conventional data transfer apparatus, in order to achieve asynchronous data passing between the operating clock of the data disk 1 and the operating clock of the DRAM 9 and the DRAM control circuit 8, the operating clock of the DRAM 9 and the DRAM control circuit 8 must be sufficiently higher than the operating clock of the data disk 1.

Moreover, in the conventional data transfer apparatus, while the input data are stored in the FIFO buffer 5, the amount of transmitted data is checked with the data interpolation circuit 20, and further dummy data for interpolation are generated and inserted in the input data. Therefore, if the FIFO buffer 5 does not have a sufficient capacity, data storage is not carried out smoothly because of delay due to the interpolation, resulting in missing data. However, to increase the capacity of the FIFO buffer 5 to avoid such situation leads to increased circuit scale and cost up.

### SUMMARY OF THE INVENTION

The present invention is made to solve the above-described problems and has for its object to provide a data transfer apparatus that reduces the number to accesses to the DRAM from the error correction circuit during data transmission, and reduces the number of accesses to the DRAM by transferring read data to the DRAM not in 1-byte unit but in a predetermined unit, thereby improving the system performance.

Another object of the present invention is to provide a data transfer apparatus that performs data transfer without increasing the operating clock frequency of the DRAM and the DRAM control circuit even when the operating clock frequency of the recording medium is increased for speed-up of data reading from the recording medium.

Still another object of the present invention is to provide a data transfer apparatus that realizes a data transfer state equivalent to the state where interpolation for missing data is carried out, to deal with missing data without increasing the capacity of the FIFO buffer in the previous stage.

A further object of the present invention is to provide a data transfer method that reduces the number of accesses to the DRAM from the error correction circuit during data transmission, and reduces the number of accesses to the DRAM by transferring read data to the DRAM not in 1-byte unit but in a predetermined unit, thereby improving the system performance.

Other objects and advantages of the invention will become apparent from the detailed description that follows. The detailed description and specific embodiments described are provided only for illustration since various additions and modifications within the scope of the invention will be apparent to those of skill in the art from the detailed description.

According to a first aspect of the present invention, there is provided a data transfer apparatus for transferring sequentially inputted data that have one piece of synchronization data for every m pieces of data and are to be processed in units of data processing each comprising m×n pieces of data, which data transfer apparatus performs synchronization on the successively inputted data by using the synchronization data when performing the data transfer, and the data transfer apparatus comprises: data storage means, in which storage positions are specified on the basis of the number of times the synchronization data is transferred, for holding data that arc stored in the specified storage positions; storage address generation means for generating storage addresses indicating the storage positions in the data storage means so that the data are sequentially stored in the specified storage positions in the data storage means when the synchronization data is detected; storage control means for controlling the data storage into the data storage means, using the storage addresses generated by the storage address generation means; read address generation means for generating read addresses indicating the storage positions in the data storage means so that the data stored in the data storage means are sequentially read out; reading control means for controlling the data reading from the data storage means, by using the read addresses generated by the read address generation means; arbitration means for arbitrating the data storage operation of the storage control means and the data reading operation of the reading control means, in/from the data storage means; and data conversion means for converting the data read by the reading control means, into predetermined units of data. This data transfer apparatus allows asynchronous access to the data storage means, and allows asynchronous data passing without increasing the clock frequency of the control means even when the frequency of the operating clock of the recording medium is increased.

According to a second aspect of the present invention, in the data transfer apparatus of the first aspect, the storage address generation means comprises: scale-of-m counting means for counting the sequentially inputted data according to the base m numbering system, which counting means is initialized when the synchronization data is detected; scale-of-n counting means for counting carries of the scale-of-m counting means, according to the base n numbering system, with the data processing unit comprising m×n pieces of data; scale-of-i counting means for counting the data according to the base i numbering system, which counting means generates an offset value for every data storage unit so that i pieces of data processing units are stored in the data storage means; offset value generation means for generating an offset value on the basis of the count value of the scale-of-i counting means; and storage address generation means for generating the storage addresses indicating the storage positions in the data storage means, on the basis of the count value of the scale-of-m counting means, the count value of the scale-of-n counting means, and the count value of the scale-of-i counting means. This data transfer apparatus allows storage position correction for storing data that follows a data sync signal (synchronous data) in correct positions in the data storage means, whereby a remedy for missing data by data interpolation in the previous buffering process is dispensed with. Therefore, it is not necessary to increase the buffer capacity to avoid influence of delay due to the interpolation. As the result, a remedy for missing data can be achieved without increasing the circuit scale and cost.

According to a third aspect of the present invention, in the data transfer apparatus of the first aspect, the read address generation means comprises: scale-of-m×n counting means for counting the read data stored in the data storage means, according to the base m×n numbering system; scale-of-i counting means for counting the data according to the base i numbering system, which counting means generates an offset value for every data storage unit so that i pieces of data processing units stored in the data storage means are read out; offset value generation means for generating an offset value on the basis of the count value of the scale-of-i counting means; and read address generation means for generating the read addresses indicating the data reading positions in the data storage means, on the basis of the count value of the scale-of-m×n counting means, and the count value of the scale-of-i counting means. Therefore, this data transfer apparatus can execute error correction by temporarily accessing the data storage means without accessing a DRAM, whereby the number of access times to the DRAM is reduced, and the system performance is improved without increasing the operating clock frequency of the system.

According to a fourth aspect to the present invention, in the data transfer apparatus of the first aspect, the data conversion means converts the data read from the data storage means by the reading control means using the addresses generated by the read address generation means, into predetermined units of data each comprising j pieces of data; and the data conversion means is provided with data conversion backup means for making up a deficiency of data corresponding to a remainder of m×n/j. Therefore, data transfer from the data storage means that temporarily holds the data can be performed in units of j pieces of data even when n×m is not an integer multiple of j, resulting in speed-up of data transfer.

According to a fifth aspect of the present invention, there is provided a data transfer method for transferring sequentially inputted data that have one piece of synchronization data for every m pieces of data and are to be processed in units of data processing each comprising m×n pieces of data, which data transfer method performs synchronization on the successively inputted data by using the synchronization data when performing the data transfer, and the data transfer method comprises: arbitration step of arbitrating the data storage operation of storage control step described later, and the data reading operation of reading control step described later, in/from data storage means, in which storage positions are specified on the basis of the number of times the synchronization data is transferred, for holding data that are stored in the specified storage positions; storage address generation step of generating storage addresses indicating the storage positions in the data storage means so that the data are sequentially stored in the specified storage positions in the data storage means when the synchronization data is detected; storage control step of controlling the data storage into the data storage means, using the storage addresses generated in the storage address generation step; read address generation step of generating read addresses indicating the storage positions in the data storage means so that the data stored in the data storage means are sequentially read out; reading control step of controlling the data reading from the data storage means, by using the read addresses generated in the read address generation step; and data conversion step of converting the data read in the reading control step, into predetermined units of data. This data transfer method allows asynchronous access to the data storage means, and allows asynchronous data passing without increasing the operating speed of the control step even when the operating speed of the recording medium is increased.

According to a sixth aspect of the present invention, in the data transfer method of the fifth aspect, the storage address generation step comprises: scale-of-m counting step of counting the sequentially inputted data according to the base m numbering system, which counting step is initialized when the synchronization data is detected; scale-of-n counting step of counting carries of the scale-of-m counting step, according to the base n numbering system, with the data processing unit comprising m×n pieces of data; scale-of-i counting step of counting the data according to the base i numbering system, which counting step generates an offset value for every data storage unit so that i pieces of data processing units are stored in the data storage means; offset value generation step of generating an offset value on the basis of the count value of the scale-of-i counting step; and storage address generation step of generating the storage addresses indicating the storage positions in the data storage means, on the basis of the count value of the scale-of-m counting step, the count value of the scale-of-n counting step, and the count value of the scale-of-i counting step. This data transfer method allows storage position correction for storing data that follows a data sync signal (synchronous data) in correct positions in the data storage means, whereby a remedy for missing data by data interpolation in the previous buffering process is dispensed with. Therefore, it is not necessary to increase the buffer capacity to avoid influence of delay due to the interpolation. As the result, a remedy for missing data can be achieved without increasing the circuit scale and cost.

According to a seventh aspect of the present invention, in the data transfer method of the fifth aspect, the read address generation step comprises: scale-of-m×n counting step of counting the read data stored in the data storage means, according to the base m×n numbering system; scale-of-i counting step of counting the data according to the base i numbering system, which counting step generates an offset value for every data storage unit so that i pieces of data processing units stored in the data storage means are read out; offset value generation step of generating an offset value on the basis of the count value of the scale-of-i counting step; and read address generation step of generating the read addresses indicating the data reading positions in the data storage means, on the basis of the count value of the scale-of-m×n counting step, and the count value of the scale-of-i counting step In this data transfer method, error correction can be executed by temporarily accessing the data storage means without accessing a DRAM, whereby the number to access times to the DRAM is reduced, and the system performance is improved without increasing the operating speed of the system.

According to an eighth aspect of the present invention, in the data transfer method of claim 5, the data conversion step converts the data read from the data storage means in the reading control step using the addresses generated in the read address generation step, into predetermined units of data each comprising j pieces of data; and the data conversion step includes data conversion backup step of making up a deficiency of data corresponding to a remainder of m×n/j. Therefore, data transfer from the data storage means that temporarily holds the data can be performed in units of j pieces of data even when n×m is not an integer multiple of j, resulting in speed-up of data transfer.

### BRIEF DESCRIPTION OF THE DRAWINGS

FIG. 1 is a block diagram illustrating the construction of a data transfer apparatus according to an embodiment of the present invention.

FIG. 2 is a block diagram illustrating the construction of a SRAM control circuit according to the embodiment of the invention.

FIGS. 3(a) and 3(b) are block diagrams illustrating the constructions of a demodulation circuit/data transfer unit and an error correction circuit/data transfer unit according to the embodiment of the invention.

FIG. 4 is a block diagram illustrating the construction of a DRAM transfer control unit according to the embodiment of the invention.

FIGS. 5(a)-5(c) are diagrams for explaining the arrangement of data to be handled in the embodiment of the invention.

FIG. 6 is a diagram for explaining the arrangement of data to be transferred from an SRAM to a DRAM according to the embodiment of the invention.

FIGS. 7(a)-7(g) are diagrams for explaining the timings of data to be inputted according to the embodiment of the invention. FIGS. 8(a)-8(n) are diagrams for explaining data transfer from an FIFO buffer to the SRAM according to the embodiment of the invention.

FIGS. 9(a)-9(n) are diagrams for explaining data transfer from the FIFO buffer to the SRAM according to the embodiment of the invention.

FIGS. 10(a)-10(h) are diagrams for explaining data transfer from the SRAM to an error correction circuit according to the embodiment of the invention.

FIGS. 11(a)-11(q) are diagrams for explaining data transfer from the SRAM to the DRAM according to the embodiment of the invention.

FIGS. 12(a)-12(q) are diagrams for explaining data transfer from the SRAM to the DRAM according to the embodiment of the invention.

FIGS. 13(a) and 13(b) are diagrams for explaining the arrangement of data when there are missing data in the input data.

FIG. 14 is a diagram for explaining the arrangement of data to be transmitted from the SRAM to the DRAM when there are missing data in the input data.

FIGS. 15(a)-15(n) are diagrams for explaining the timings of data to be inputted when there are missing data in the input data.

FIG. 16 is a block diagram illustrating the construction of the conventional data transfer apparatus.

### DETAILED DESCRIPTION OF THE PREFERRED EMBODIMENTS

A data transfer apparatus according to an embodiment of the present invention performs data synchronous processing on input data, using a plurality of counters and an SRAM (Synchronous Random Access Memory), to realize efficient data transfer in predetermined data transfer units.

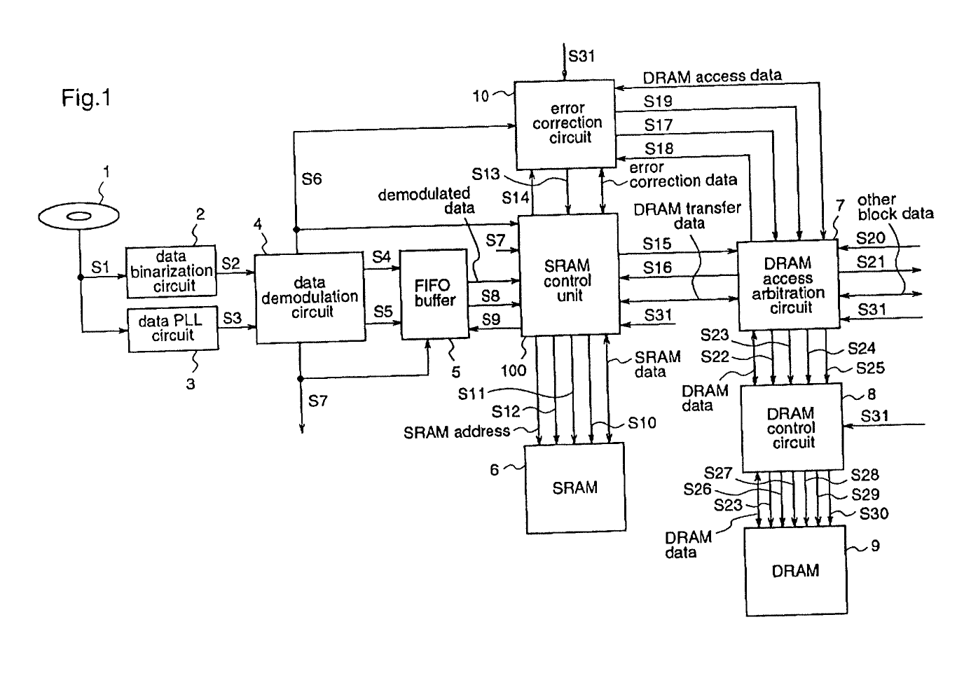

FIG. 1 is a block diagram illustrating the construction of a data transfer apparatus according to an embodiment of the invention. With reference to FIG. 1, the data transfer apparatus comprises a data disk 1, a data binarization circuit 2, a data PLL circuit 3, a data demodulation circuit 4, a FIFO buffer 5, a SRAM control unit 100, a SRAM 6, a DRAM (Dynamic Random Access Memory) 9, a DRAM access arbitration circuit 7, a DRAM control circuit 8, and an error correction circuit 10.

The data disk 1 is a recording medium on which data is recorded, and an analog data signal recorded on the data disk 1 is read as a read data signal S1. The data binarization circuit 2 converts the analog signal (read data signal) S1 read from the data disk 1 into a binary digital signal S2 of 1 or 0. Further, the data PLL circuit 3 generates a synchronous clock signal S3 that is synchronized with the read data signal S1 from the data disk 1 by PLL (Phase Locked Loop).

The data demodulation circuit 4 reads the binary digital signal S2 from the data binarization circuit 2, on the basis of the synchronous clock signal S3 from the data PLL circuit 3. Since the binary digital signal S2 has been modulated according to a specific modulation rule to improve the reliability, the data demodulation circuit 4 demodulates the modulated signal S2 to extract the original data. Further, the demodulation circuit 4 detects a data sync byte that is inserted in the binary digital signal S2 to increase the data recording precision, and outputs a data sync byte detection signal S6. The demodulated data S4 is output to the FIFO butter 5 together with a demodulation clock S5 that requests the FIFO buffer 5 to receive the demodulated data S4.

The FIFO buffer 5 is a buffer for temporarily storing data on the FIFO (first-in first-output) basis, and it holds the data until the data is transferred to the SRAM 6 under control of the SRAM control unit 100 that is described better when the demodulated data is buffered in the FIFO buffer 5, the FIFO buffer 5 outputs a demodulated data transfer request S8.

The DRAM access arbitration circuit 7 arbitrates access to the DRAM 9 to control data input/output.

The DRAM control circuit 8 generates a timing to access the DRAM 9, and makes access to the DRAM 9.

When the demodulated data S4 has an error, the error correction circuit 10 checks and corrects the error using redundant codes attached to the demodulated data S4.

The DRAM 9 functions as a data storage means for holding data used for arithmetic processing or the like, in a storage position specified by addresses. The DRAM 9 specifies a storage position using a column address indicating the storage position in the vertical direction and a row address indicating the storage position in the horizontal direction. The column address and the row address are usually inputted as the same address signal line S23. So, in order to make a distinction between the column address and the row address, a RAS (Row Address Strobe) signal S27 and a CAS (Column Address Strobe) signal S28 are transmitted.

The SRAM 6 functions as a data storage means for holding data used for arithmetic processing or the like, in a storage position specified by addresses. In contrast with the DRAM 9, the SRAM 6 can specify all storage positions with a single sequence of addresses, that is, it does not need to make a distinction between a column address and a row address, resulting in high-speed access. However, the SRAM 6 has a drawback that it is larger in the unit size than the DRAM 9. With respect to the SRAM 6 of this embodiment, the address width is 9 bits, the data width is 8 bits (1 byte), and the capacity is 4K bits.

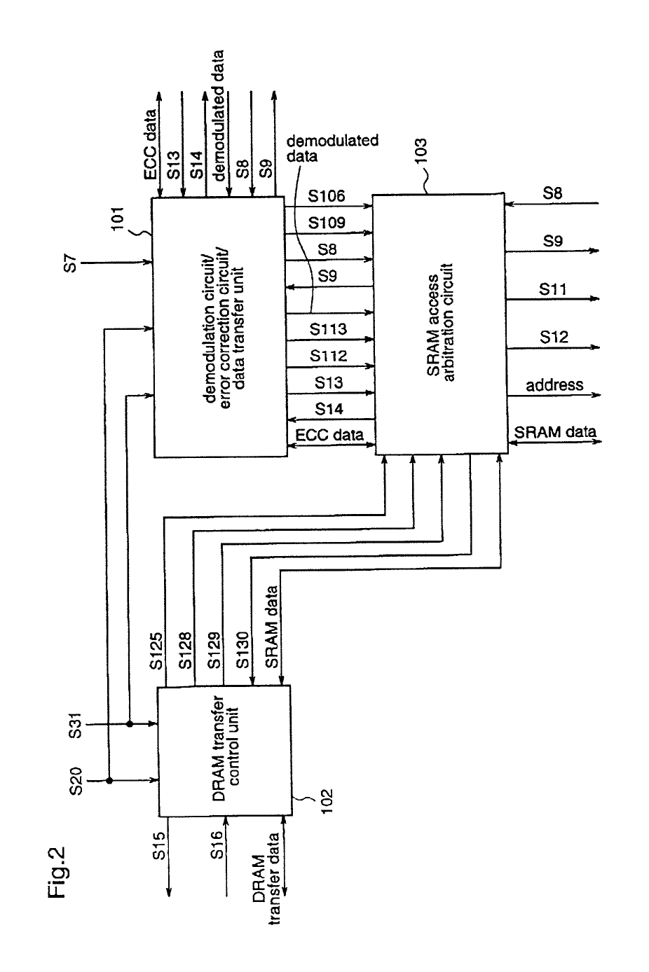

As shown in FIG. 2, the SRAM control unit 100 comprises a demodulation circuit/error correction circuit/data transfer unit 101 for generating addresses and access timings to the SRAM 6; a DRAM transfer control circuit 102 for generating addresses and access timings to the SRAM 6, and converting the SRAM data unit into a predetermined data unit; and a SRAM access arbitration circuit 103 for arbitrating accesses from the demodulation circuit/error correction circuit/data transfer unit 101 and the DRAM transfer control unit 102 to the SRAM 6, and controlling data reading and writing.

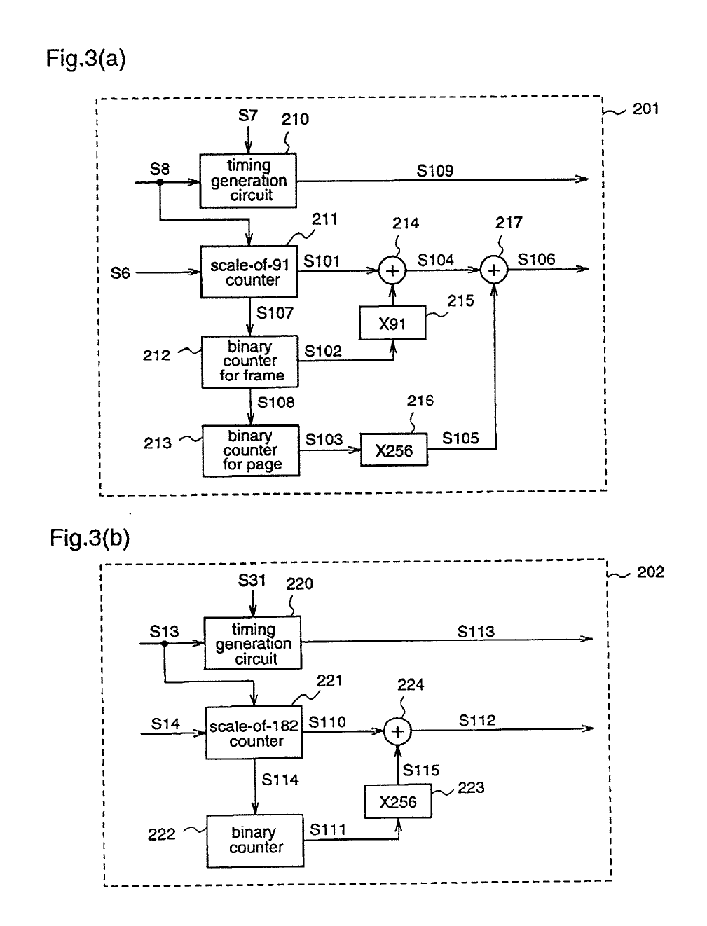

Further, the demodulation circuit/error correction circuit/data transfer apparatus 101 (FIG. 2) comprises a demodulation circuit/data transfer unit 201 shown in FIG. 3(a) and an error correction circuit/data transfer unit 202 shown in FIG. 3(b). The demodulation circuit/data transfer unit 201 serves as a generator of storage addresses to the SRAM 6, and comprises a timing generation circuit 210 for generating an access timing to the SRAM 6, a scale-of-91 counter 211, a binary counter 212 for frame (hereinafter referred to as a frame binary counter), a binary counter 213 for page (hereinafter referred to as a page binary counter), an adder 214, a X91 multiplier 215, a X256 multiplier 216, and an adder 217. The error correction circuit/data transfer unit 202 servers as a generator of read addresses to the SRAM 6, and comprises a timing generation circuit 220 for generating an access timing to the SRAM 6, a scale-of-182 counter 221, a binary counter 222, a X256 multiplier 223, and an adder 224. The demodulation circuit/error correction circuit/data transfer unit 101 so constructed generates a storage address to the SRAM 6, of the demodulated data S4 supplied from the FIFO buffer 5, and arbitrates data access from the error correction circuit 10, and generates a read address to the SRAM 6.

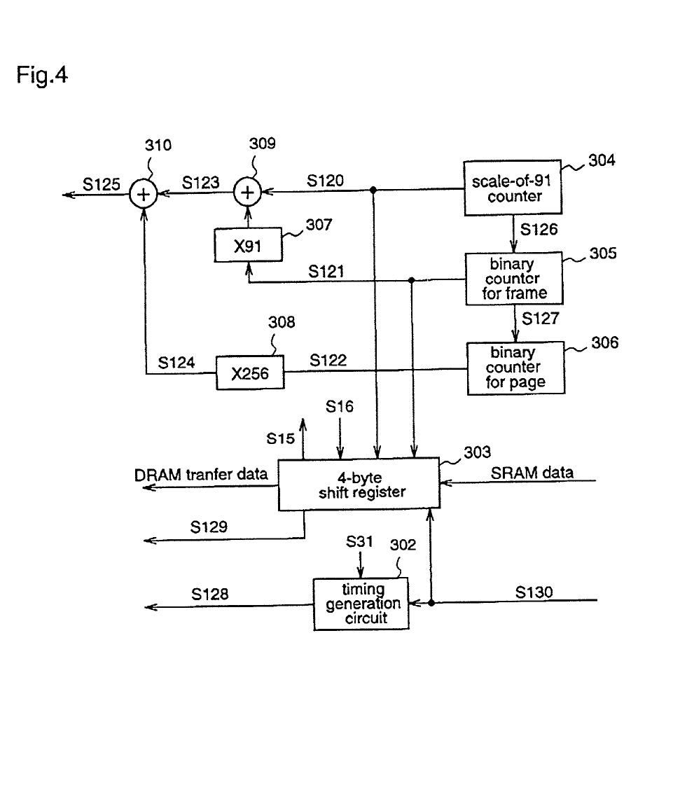

Further, as shown in FIG. 4, the DRAM transfer control circuit 102 shown in FIG. 2 comprises a timing generation circuit 302 for generating an access timing to the SRAM 6, a shift register 303 for converting a 1-byte (8 bits) unit data sequence from the SRAM 6 into a 4-byte (32 bits) unit data sequence, a scale-of-91 counter 304, a frame binary counter 305, a page binary counter 306, a X91 multiplier 307, a X256 multiplier 308, an adder 309, and an adder 310. The DRAM transfer control circuit 102 generates a read address indicating the transferred data storage position to the SRAM 6, and converts the data unit of the SRAM data into the data unit of the DRAM transfer data, and generates a transfer request signal S15 to the DRAM access arbitration circuit 7. The respective counters, arithmetic circuits, and other circuits included in each unit of the SRAM control unit 100 will be described later.

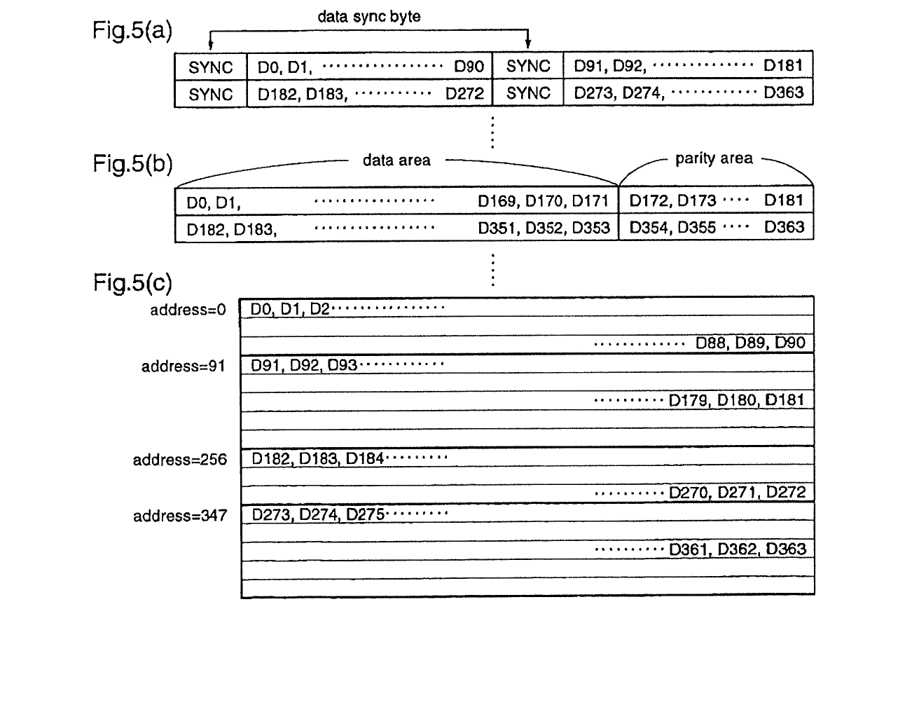

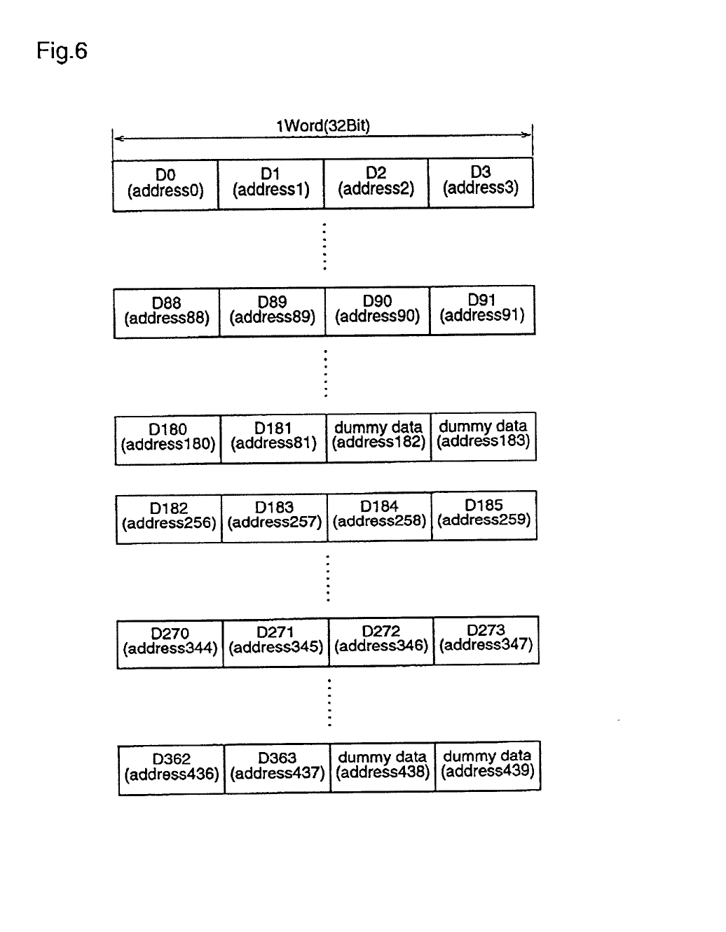

Hereinafter, a description will be given of the structure of the data to be transferred, the relationship between the data and the error correction array, the relationship between the data and the data storage state into the SRAM 6, and the structure of the data to be transferred to the DRAM 9, together with the functions of the counters, arithmetic circuits, and other circuits included in each unit of the SRAM control unit 100, with reference to FIGS. 3, 4, 5, and 6. FIG. 5 is a diagram for explaining the arrangement of data to be handled in this embodiment of the invention, and FIG. 6 is a diagram for explaining the arrangement of data to be transferred from the SRAM 6 to the DRAM 9 according to the embodiment of the invention.

To be specific, FIG. 5(a) is a diagram illustrating a recording format of data to be transferred, with respect to one frame as a data transfer unit. In other words, FIG. 5(a) is a diagram for explaining a data input format to the data demodulation circuit 4. In the frame by frame data transfer shown in FIG. 5(a), a data sync byte (SYNC) is inserted for every 91 bytes. In this format, there are arranged a first data sync byte (SYNC), 91 bytes of data D0˜D90, a second data sync byte (SYNC), 91 bytes of data D91˜D181, a third data sync byte (SYNC), . . . The 91 bytes of data are modulated, and the data sync bytes are inserted to improve the precision in data reading. Since the data sync bytes have a pattern that is not used for the modulated data, they are distinguished from the modulated data. The data sync bytes are removed from the data of this format, and demodulation corresponding to the modulation is carried out to obtain demodulated data as shown in FIG. 5(b). The demodulated data comprises 172 bytes of data D0˜D171 and 10 bytes of parity data D172˜D181. The 10 bytes of parity data are redundant data to be used for correcting errors in the demodulated data. The data area of 172 bytes and the parity area of 10 bytes (182 bytes in total) are regarded as one unit of data processing, i.e., one unit of data transfer. FIG. 5(c) shows a memory map of the SRAM 6, along which the demodulated data are stored in the SRAM 6. In this embodiment of the invention, the SRAM 6 has the address width of 9 bits, the data width of 8 bits (1 byte), and the capacity of 4K bits. In this SRAM 6, as shown in FIG. 5(c), the demodulated data D0, D1, D2, . . . are sequentially stored from the address “0”, and the demodulated data D91, D92, D93, . . . are sequentially stored from the address “91”. Further, the demodulated data D182, D183, D184, . . . are sequentially stored from the address “256”, and the demodulated data D273, D274, D275, . . . are sequentially stored from the address “347”. In this way, two data processing units, each comprising 182 bytes (172 bytes in the data area and 10 bytes in the parity area), are stored in the SRAM 6 having the capacity of 4K bytes.

Next, a description will be given of storage of the 182 bytes of data (172 bytes in the data area+10 bytes in the parity area) into the SRAM 6, reading of these data from the SRAM 6, and transfer of these data to the error correction circuit 10, together with the functions of the counters, arithmetic circuits, and other circuits included in each unit of the SRAM control unit 100.

The counters, multipliers, adders, and timing generation circuit included in the demodulation circuit/data transfer unit 201 (FIG. 3(a)) used for storing the data into the SRAM 6, operate as follows.

The timing generation circuit 210 generates a timing to store the data into the SRAM 6.

The scale-of-91 counter 211 is a counter for counting 91 bytes of data between adjacent data sync bytes (SYNC). On receipt of a demodulated data transfer request signal S8 from the FIFO buffer 5, the scale-of-91 counter 211 counts the number of data to be transferred, according to the base 91 numbering system, and when there is a carry, the counter 211 outputs a carry signal S107 indicating this carry to the frame binary counter 212. Further, on receipt of a data sync byte detection signal S6 outputted from the data demodulation circuit 4, the scale-of-91 counter 211 outputs a carry signal S107 to the frame binary counter 212, and the count of the counter 211 is cleared to 0.

The frame binary counter 212 is a counter for counting the number of frames within the data transfer unit of 182 bytes when the 91 bytes of data between the data sync bytes are regarded as one unit (one frame). On receipt of the carry signal S107 from the scale-of-91 counter 211, the frame binary counter 212 counts the carry digit in the counter 211 according to the binary numbering system, and when there is a carry, the frame binary counter 212 outputs a carry signal S108 indicating this carry to the page binary counter 213.

The adder 214 adds the count S101 of the scale-of-91 counter 211 to a product obtained by multiplying the count S102 of the frame binary counter 212 with 91 by the Y91 multiplier 215, and outputs the sum S104.

The page binary counter 213 is a counter for counting the data transfer unit of 182 bytes. On receipt of the carry signal S108 from the frame binary counter 212, the page binary counter 213 counts the carry digit in the frame binary counter 212, according to the binary numbering system.

The X256 multiplier 216 multiplies the count S103 of the page binary counter 213 by 256, and outputs the result of multiplication as a X256 value S105.

The adder 217 adds the sum S104 to the X256 value S105, and outputs the sum S106. The sum S106 outputted from the adder 217 is the data storage address to the SRAM 6, that is, the demodulated data transfer SRAM address S106.

As described above, two units of 182 bytes (172 bytes in the data area+10 bytes in the parity area) can be stored in the SRAM 6, as shown in the memory map of FIG. 5(c), by using the scale-of-91 counter 211, the frame binary counter 212, the page binary counter 213, the adder 214, the X91 multiplier 215, the X256 multiplier 216, the adder 217, and the timing generation circuit 210.

On the other hand, the respective counters, multipliers, adders, and circuits included in the error correction circuit/data transfer unit 202 (see FIG. 3(b)) used for reading the data from the SRAM 6 and transferring the data to the error correction circuit 10 (see FIG. 1), operate as follows.

The scale-of-182 counter 221 is a counter according to the base 182 numbering system, and counts up on receipt of a data transfer request signal S13 from the error correction circuit 10 (FIG. 1).

The binary counter 222 is a counter according to the binary numbering system, and counts up on receipt of a carry signal S114 from the scale-of-182 counter 221.

The X256 multiplier 223 multiplies the count S111 of the binary counter 222 by 256, and outputs the result of multiplication as a X256 value S115. The adder 224 adds the count S110 of the scale-of-182 counter 221 to the X256 value S115, and outputs the sum S112. The sum S112 outputted from the adder 224 is the data read address to the SRAM 6, that is, the error correction circuit data transfer address S112.

FIG. 6 shows the data transfer situation wherein the data stored in the SRAM 6 are transferred in word units (32 bits or 4 bytes) to the DRAM 9. As shown in FIG. 6, when transferring one data unit comprising 182 bytes (172 bytes in the data area+10 bytes in the parity area), if the data transfer is carried out word by word, the last two bytes of data, i.e., D180 and D181, become residual data. If the residual data D180 and D181 and the following data D182 and D183 are transferred as one word, the processing unit of 182 bytes (172 bytes in the data area+10 bytes in the parity area) is destroyed. In order to avoid this, the residual data D180 and D181 and two bytes of dummy data remaining on the SRAM 6 are combined as one word, and the data from D0 to D181 are transferred in word units. Further, as for the data D182 onward, transfer is carried out from the beginning of one word (i.e., word boundary), whereby data transfer is achieved without destroying the data processing unit.

Next, a description will be given of the operations of the respective counters, arithmetic circuits, and other circuits included in each unit of the SRAM control unit 100 when 182 bytes of data (172 bytes in the data area+10 bytes in the parity area) are transferred from the SRAM 6 to the DRAM 9.

The respective counters, multipliers, adders, and timing generation circuit included in the DRAM transfer control unit 102 (FIG. 4) used for transferring the data as described with respect to FIG. 6, operate as follows.

The scale-of-91 counter 304 is a counter for counting 91 bytes of data between adjacent data sync bytes (SYNC), when reading the data stored in the SRAM 6 (see FIG. 1), and the counter 304 sequentially counts up the data according to the base 91 numbering system. When 91 bytes of data between adjacent data sync bytes, among the data stored in the SRAM 6 (FIG. 1), are regarded as one unit (one frame), the frame binary counter 305 counts the one unit (one frame) on receipt of a carry signal S126 from the scale-of-91 counter 304, according to the binary numbering system. The page binary counter 306 counts one frame (one unit) comprising 91 bytes of data between adjacent data sync bytes, on receipt of a carry signal S127 from the frame binary counter 305, according to the binary numbering system.

The adder 309 adds the count S120 of the scale-of-91 counter 304 to a product obtained by multiplying the count S121 of the frame binary counter 305 with 91 by the X91 multiplier 307, and outputs the sum S123.

The X256 multiplier 308 multiplies the count S122 of the page binary counter 306 by 256, and outputs the product as a X256 value S124.

The adder 310 adds the sum S123 from the adder 309 to the X256 value S124 from the X256 multiplier 308, and outputs the sum S125. The sum S125 outputted from the adder 310 is the data read address to the SRAM 6, that is, the DRAM data transfer SRAM address S125.

The 4-byte shift register 303 specifies the data read address S125 to the SRAM 6 and reads the data stored in the SRAM 6, and temporarily holds the read data for every four bytes (four times of reading) by sequential shifting, thereby converting the data that is read from the SRAM 6 in units of one byte to the data in units of four bytes.

The timing generation circuit 302 generates a timing of a read signal for reading the data from the SRAM 6 (FIG. 1).

In this way, it is possible to perform data transfer in units of one word (32 bits) from the SRAM 6 to the DRAM 9 as shown in FIG. 6, by using the scale-of-91 counter 304, the frame binary counter 305, the page binary counter 306, the adder 309, the X91 multiplier 307, the X256 multiplier 308, the adder 310, the 4-byte shift register 303, and the timing generation circuit 302.

Next, the operation of the data transfer apparatus according to the embodiment of the invention when the data S1 read from the data disk 1 is temporarily stored in the SRAM 6 and then transferred to the DRAM 9, will he described with respect to the separated steps as follows: A. Preparation for data storage to SRAM, B. Data storage to SRAM, C. Error correction, and D. Data transfer from SRAM to DRAM.

[A. Preparation for data storage to SRAM]

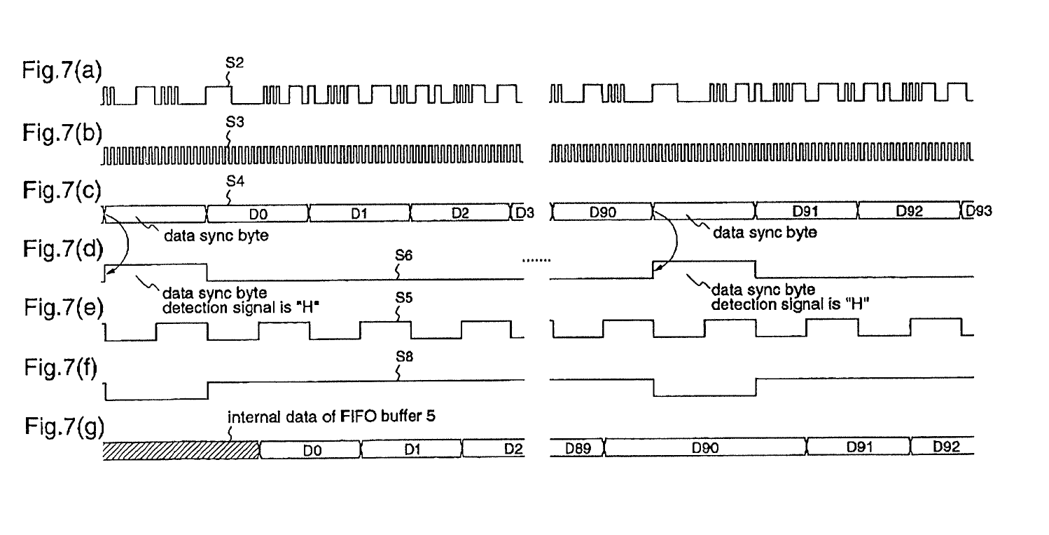

Initially, the operations of the respective signals to be transferred from the data disk 1 to the FIFO buffer 5 will be described with reference to FIGS. 7(a)-7(g).

FIGS. 7(a)-7(g) are diagrams for explaining the data input timing according to the embodiment of the invention.

FIG. 7(a) shows the timing of a binary digital signal S2 obtained by converting the data signal S1 that is read from the data disk 1, from an analog signal to a binary digital signal of 0 or 1, by the data binarization circuit 2. FIG. 7(b) Shows the timing of a sync clock S3 of the data signal S1 read from the data disk 1, that is generated from the read data signal S1 by the data PLL circuit 3. The data demodulation circuit 4 captures the binary digital signal S2 at the timing of this sync clock S3. As described above, since the binary digital signal S2 has been modulated according to a specific modulation rule to improve the reliability of the data, the data demodulation circuit 4 performs demodulation. During the demodulation, specific data patterns, which do not exist in the modulation rule, are inserted to improve the reading precision, and these specific data patterns are detected as data sync bytes. Amongst the data sync bytes, a first data sync byte in the data recording unit (sector) of the data disk 1 can be identified by a specific code that follows the data sync byte and, therefore, the first data sync byte detection in the data recording unit (sector) can be recognized. Initially, the demodulation circuit 4 performs detection of the first data sync byte in the data recording unit (sector). When the demodulation circuit 4 detects the first data sync byte, the demodulation circuit 4 performs demodulation at the timing of the detection of the data sync byte, and outputs the demodulated data D0, D1, D2, . . . FIG. 7(c) shows the timings of signals indicating the data sync byte detection and the demodulated data output, and they are outputted as the demodulated data S4 to the FIFO buffer 5.

FIG. 7(d) shows the timing of a data sync byte detection signal S6 for notifying other blocks that the data sync byte is detected, and “H” is outputted as the data sync byte detection signal S6 when the data sync byte shown in FIG. 7(c) is detected, thereby notifying that the data sync byte is detected. FIG. 7(e) shows the timing of a demodulation clock S5 at which the FIFO buffer 5 captures the demodulated data S4. When the binary digital signal S2 outputted from the data binarization circuit 2 is serially inputted and demodulated by the data demodulation circuit 4, the demodulated data S4 is converted from 16 bits (binary digital signal S2) into 8 bits, whereby the data sync clock S3 of the data PLL circuit 3 is also frequency-divided according to the 8-bit unit data, and outputted as the demodulation clock S5 from the data demodulation circuit 4 to the FIFO buffer 5.

FIG. 7(f) shows the timing of a demodulated data transfer request signal S8 indicating the effectiveness of the demodulated data S4 from the data demodulation circuit 4. Since the FIFO buffer 5 should not capture the demodulated data S4 during detection of the data sync pattern, “L” is outputted indicating that the demodulated data S4 is ineffective FIG. 7(g) shows the timing of data input to the FIFO buffer 5. The FIFO buffer 5 judges the effectiveness of the demodulated data transfer request signal S8 at the rising timing of the demodulation clock S5, and captures only effective demodulated data. Since the FIFO buffer 5 is a buffer for temporarily holding the data on the FIFO (first-in first-out) basis, it nullifies the data sync byte detection, and sequentially buffers the data D0, D1, D2, . . . , D90, and sequentially outputs the data D0, D1, D2, . . . , D90. When the data up to D90 have been transferred, the FIFO buffer 5 detects the second data sync byte that is inserted in the demodulated data S4 to improve the reliability in data reading, and outputs a data sync byte detection signal S6. During the period of the data sync byte detection, the FIFO buffer 5 captures no data with reference to the demodulated data transfer request signal S8. When the demodulated data transfer request signal S8 becomes effective, the FIFO buffer 5 sequentially buffers the data D91, D92, D93, . . . , D181, and sequentially outputs these data. Thereafter, the FIFO buffer 5 sequentially captures and outputs the data D182, D183, . . . , D272 after detection of the third data, and the data D273, D274, . . . , D363 after detection of the fourth data sync byte.

[B. Data storage into SRAM]

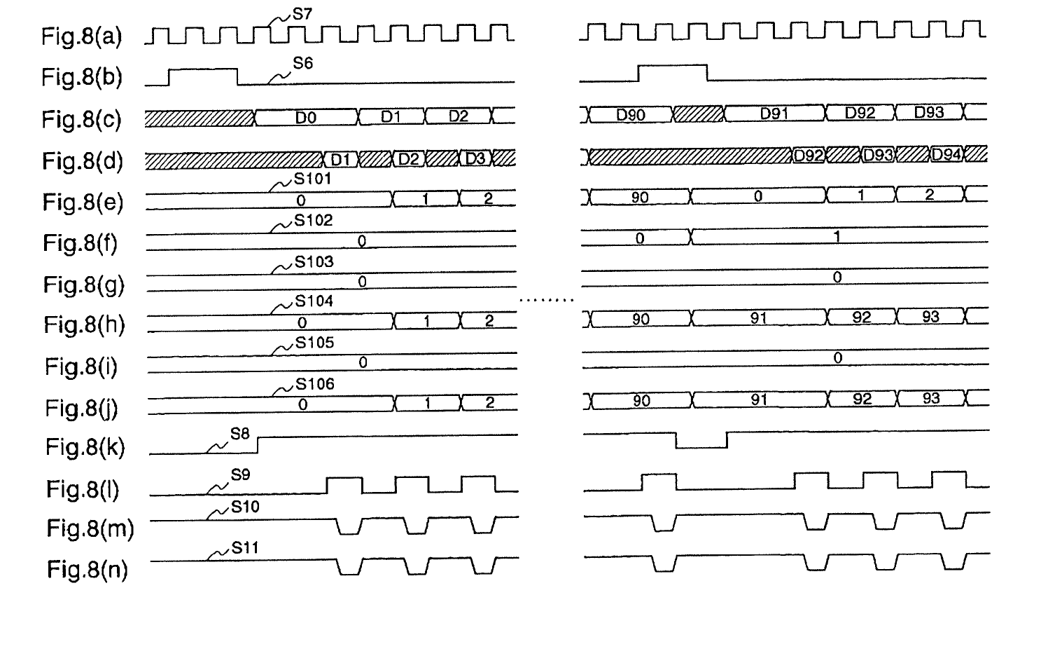

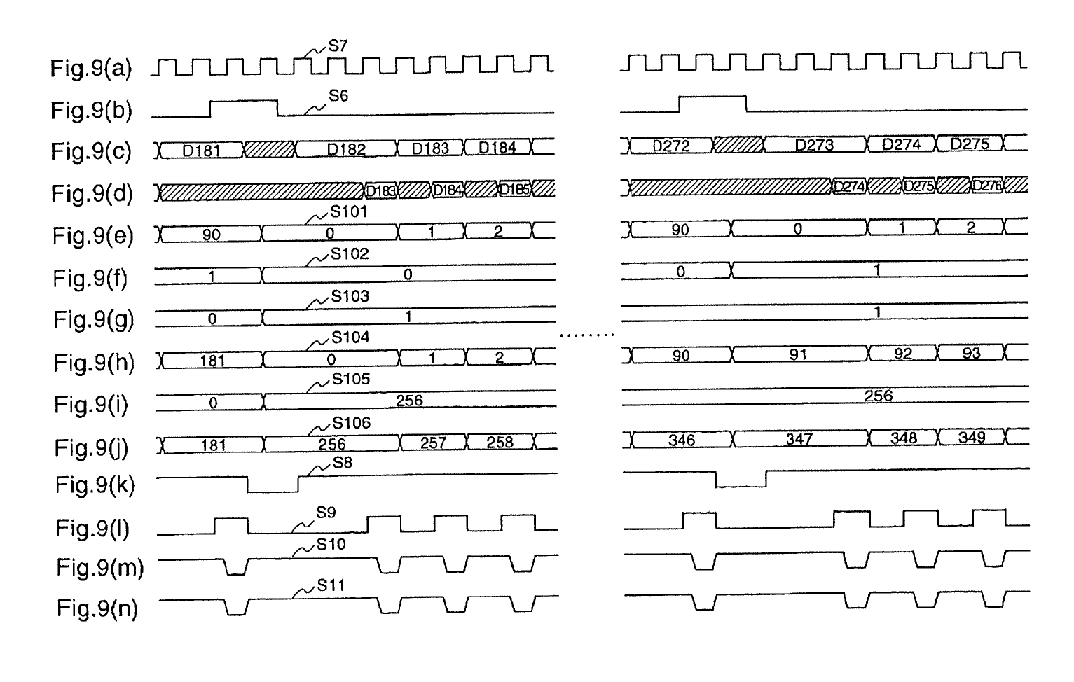

Hereinafter, a description will be given of the operations of the respective signals until the data buffered in and sequentially outputted from the FIFO buffer 5 are stored in the SRAM 6, with reference to FIGS. 8 and 9.

FIGS. 8 and 9 are diagrams for explaining data transfer from the FIFO buffer 5 to the SRAM 6, according to the embodiment of the present invention.

FIG. 8 is a diagram for explaining detection of the first data sync byte, transfer of D0, D1, . . . , D90, detection of the second data sync byte, and transfer of D91, D92, and D93. FIG. 9 is a diagram for explaining transfer of D181, detection of the third data sync byte, transfer of D182, D183, . . . , D272, detection of the fourth data sync byte, and transfer of D273, D274, and D275.

FIG. 8(a) (FIG. 9(a)) shows a transfer clock S7 outputted from the data demodulation circuit 4. The transfer clock S7 is in the same phase as the demodulation clock S5 that is used for data transfer from the data demodulation circuit 4 to the FIFO buffer 5, but the cycle of the transfer clock 37 is shorter than that of the demodulation clock S5. In this embodiment of the invention, the cycle of the transfer clock S7 is half the cycle of the demodulation clock S5. The cycle of the transfer clock S7 may be shorter or longer than half the cycle of the demodulation clock S5 so long as these clocks S3 and S5 are in the same phase, and it depends on the performance of the apparatus.

FIG. 8(b) (FIG. 9(b)) shows a data sync byte detection signal S6 and, as described above, this signal S6 is outputted when the data demodulation circuit 4 detects a data sync byte from the binary digital signal S2.

FIGS. 8(c) and 8(d) (FIGS. 9(c) and 9(d)) show part of the internal buffer state of the FIFO buffer 5. To be specific, FIG. 8(c) (FIG. 9(c)) shows the buffer state of the FO (first out) part on the FIFO basis, and FIG. 8(d) (FIG. 9(d)) shows the buffer state of the second FO part.

FIGS. 8(e),(f),(g),(h),(i),(j) (FIGS. 9(e),(f),(g),(h), (i), (j)) show the states of the respective internal signals of the demodulation circuit/data transfer unit 201.

FIG. 8(k) (FIG. 9(k)) shows a demodulated data transfer request signal S8 from the FIFO buffer 5 to the SRAM 6, and this transfer request signal S8 is outputted to the SRAM control unit 100 when the demodulated data is buffered in the FIFO buffer 5.

FIG. 8(1) (FIG. 9(l)) shows a demodulated data transfer request response signal S9. When the SRAM access arbitration circuit 103 in the SRAM control unit 100 receives the demodulated data transfer request signal S8, it arbitrates the transfer requests from the error correction circuit 10 and the DRAM transfer control unit 102. When the SRAM access arbitration circuit 103 judges that data transfer to the SRAM 6 is possible, it outputs the demodulated data transfer request response signal S9 to the FIFO buffer 5.

FIGS. 8(m) and 8(n) (FIGS. 9(m) and 9(n)) show a chip select signal S10 and a write enable signal S11, respectively, for data writing to the SRAM 6.

As described above, it is assumed that there are 91 bytes of data between adjacent data sync bytes, and 182 bytes of data that follow two data sync bytes are one processing unit, and two processing units, i.e., 364 bytes of data, are stored in the SRAM 6 (refer to FIG. 5).

Initially, a description will be given of the operations of the respective signals in data transfer of the first data processing unit of 182 bytes (D0˜D181) from the FIFO buffer 5 to the SRAM 6, with reference to FIG. 8.

First of all, the data demodulation circuit 4 detects the first data sync byte. Thereby, the data sync byte detection signal S6 (FIG. 8(b)) is outputted from the data demodulation circuit 4. At this point of time, the scale-of-91 counter 211, the frame binary counter 212, and the page binary counter 213, which arc included in the demodulation circuit/data transfer unit 201, are initialized, and the respective counters output “0” (FIGS. 8(e),(f),(g)). Therefore, the sum S104 (FIG. 8(h)) from the adder 214 and the X256 value S105 (FIG. 8(i)) from the X256 multiplier 216 are “0”, respectively. Consequently, the output from the adder 217, i.e., the demodulated data transfer SRAM address S106 (FIG. 8(j)), is “0”.

After the detection of the first data sync byte, the data demodulation circuit 4 transfers the demodulated data D0 to the FIFO buffer 5. When the demodulated data D0 is stored in the first-stage buffer (FIG. 8(c)) of the FIFO buffer 5, the FIFO buffer 5 outputs a demodulated data transfer request signal S8 (FIG. 8(k)) to the SRAM access arbitration circuit 103. While the data D0 is held in the first-stage buffer of the FIFO buffer 5, if the data D1 is transferred from the data demodulation circuit 4 to the FIFO buffer 5, the data D1 is stored in the second-stage buffer (FIG. 8(d)) of the FIFO buffer 5. In this way, the FIFO buffer 5 enables data transfer without halting the demodulation of the data demodulation circuit 4 even when the transfer request to the SRAM 6 is kept waiting. The SRAM access arbitration circuit 103 arbitrates access to the SRAM 6 according to the demodulated data transfer request signal S8 from the FIFO buffer 5, and outputs a demodulated data transfer request response signal S9 (FIG. 8(l)) when access is possible. On receipt of the demodulated data transfer request response signal S9, the timing generation circuit 210 in the demodulation circuit/data transfer unit 201 outputs a chip select signal S10 (FIG. 8(m)) and a write enable signal S11 (FIG. 8(n)) to the SRAM 6. When the chip select signal 310 and the write enable signal S11 are outputted, since the demodulated data transfer SRAM address S106 (FIG. 8(j)) indicates “0” and the data D0 is stored in the first-stage buffer (FIG. 8(c)) of the FIFO buffer, the data D0 is transferred to the address 0 of the SRAM 6. When the first data transfer is ended, the demodulated data transfer request response signal S9 (FIG. 8(l)) becomes disable. When the transfer of D0 is ended, the FIFO buffer 5 transfers the data D1 stored in the second-stage buffer to the first-stage buffer. At this point of time, since the demodulated data transfer request signal S8 (FIG. 8(k)) has already been outputted, the SRAM access arbitration circuit 103 performs arbitration again, and outputs a demodulated data transfer request response signal S9 (FIG. 8(l)). When the demodulated data transfer request response signal S9 (FIG. 8(l)) is outputted, since the next data D1 is to be transferred, the scale-of-91 counter 211 counts up to “1”. The output of the frame binary counter 212 remains at “0” as no carry signal S107 is supplied from the scale-of-91 counter 211, and the output of the page binary counter 213 remains at “0” as no carry signal S108 is supplied from the frame binary counter 212, consequently, the output of the adder 214, i.e., the sum S104 (FIG. 8(h)), is “1”, and the output of the X256 multiplier 216, i.e., the X256 value S105 (FIG. 8(i)), is “0”. Therefore, the output of the adder 217, i.e., the demodulated data transfer SRAM address S106 (FIG. 8(j)), indicates “1”. Accordingly, the data D1 is stored in the address “1” of the SRAM 6. The same operation as described above is repeated for the data D2, D3, . . . , D90.

When the data prior to D90 have been transferred, since the data sync byte is inserted between D90 and D91, the data D90 is transferred. When the data sync byte is detected, the data sync byte detection signal S6 (FIG. 8(b)) is outputted, and the count “90” of the scale-of-91 counter 211 in the demodulation circuit/data transfer unit 201 is cleared to “0” (FIG. 8(e)). At this time, the scale-of-91 counter 211 outputs a carry signal S107, whereby the count of the frame binary counter 212 changes from “0” to “1” (FIG. 8(f)). Since there is no carry signal S108 from the frame binary counter 212, the count of the page binary counter 213 remains at “0” (FIG. 8(g)). Since the count of the scale-of-91 counter 211 is “0” and the count of the frame binary counter 212 is “1”, the sum S104 from the adder 214 is “91” (FIG. 8(h)). Further, since the count S103 of the page binary counter 213 is “0”, the X256 value S105 from the X256 multiplier 216 is “0” (FIG. 8(i)). Since the demodulated data transfer SRAM address output S106 (i.e., the output from the adder 217) is the sum of “91” and “0”, it becomes “91”, and the data D91 after the detection of the data sync byte is transferred to the address “91” on the SRAM 6. When the data D91 has been transferred, the scale-of-91 counter 211 counts up from “0” to “1” (FIG. 8 (e)) The frame binary counter 212 holds “1” (FIG. 8(f)) as no carry signal S107 is supplied from the scale-of-91 counter 211, and the page binary counter 213 holds “0” (FIG. 8(g)) as no carry signal S108 is supplied from the frame binary counter 212. Since the count S101 of the scale-of-91 counter 211, the count 3102 of the frame binary counter 212, and the count S103 of the page binary counter 213 are “1”, “1”, and “0”, respectively, the demodulated data transfer SRAM address S106 (FIG. 8(j)) outputted from the adder 217 is “92”, whereby the data D92 that follows the data D91 is transferred to the SRAM address “92”. Thereafter, the subsequent data D93, . . . are transferred to the SRAM address “93”, . . . , respectively.

Next, a description will be given of data transfer for the second data processing unit of 182 bytes (D182˜D363) from the FIFO buffer 5 to the SRAM 6, with reference to FIG. 9.

When the data transfer of the first data process unit of 182 bytes (D0·D181) reaches the last data D181, since the data transfer byte is inserted between D181 and D182, the data D181 is transferred and, thereafter, the data sync byte is detected, and a data sync byte detection signal S6 (FIG. 9(b)) is outputted, whereby the count “90” of the scale-of-91 counter 211 in the demodulation circuit/data transfer unit 201 is cleared to “0” (FIG. 9(e)). At this time, since the scale-of-91 counter 211 outputs a carry signal S107, the count of the frame binary counter 212 changes from “1” to “0” (FIG. 9(f)). Since the frame binary counter 212 outputs a carry signal S108, the count of the page binary counter 213 changes from “0” to “1” (FIG. 9(g)). Since the count of the scale-of-91 counter 211 is “0” and the count of the frame binary counter 212 is “0”, the sum S104 from the adder 214 is “0” (FIG. 9(h)). Further, since the count S103 of the page binary counter 213 is “1”, the X256 value S105 from the X256 multiplier 216 is “256” (FIG. 9(i)). Since the demodulated data transfer SRAM address S106 outputted from the adder 217 is the sum of “0” and “256”, it is “256”, and the data D182 after detection of the data sync byte is transferred to the address “256” on the SRAM 6. When the data D182 has been transferred, the scale-of-91 counter 211 counts up from “0” to “1” (FIG. 9(c)). The frame binary counter 212 holds “0” (FIG. 9(f)) as no carry signal 3107 is supplied from the scale-of-91 counter 211, and the page binary counter 213 holds “1” (FIG. 9(g)) as no carry signal S108 is supplied from the frame binary counter 212. Since the count S101 of the scale-of-91 counter 211, the count S102 of the frame binary counter 212, and the count S103 of the page binary counter 213 are “1”, “0”, and “1”, respectively, the demodulated data transfer SRAM address S106 (FIG. 9(j)) outputted from the adder 217 is “257”, and the data D183 that follows Lie data D182 is transferred to the SRAM address “257”. Thereafter, the subsequent data D184, . . . are transferred to the SRAM address “258”, . . . , respectively.

When the data transfer reaches the last data D272, since the data transfer byte is inserted between D272 and D273, the data D272 is transferred and, thereafter, the data sync byte is detected, and a data sync byte detection signal S6 (FIG. 9(b)) is outputted, whereby the count “90” of the scale-of-91 counter 211 in the demodulation circuit/data transfer unit 201 is cleared to “0” (FIG. 9(e)). At this time, since the scale-of-91 counter 211 outputs a carry signal S107, the count of the frame binary counter 212 changes from “1” to “0” (FIG. 9(f)). Since the frame binary counter 212 outputs no carry signal S108, the count of the page binary counter 213 remains at “1” (FIG. 9(g)). Since the count of the scale-of-91 counter 211 is “0” and the count of the frame binary counter 212 is “1”, the sum S104 from the adder 214 is “91” (FIG. 9(h)). Further, since the count S103 of the page binary counter 213 is “1”, the X256 value S105 from the X256 multiplier 216 is “256” (FIG. 9(i)). Since the demodulated data transfer SRAM address S106 outputted from the adder 217 is the sum of “91” and “256”, it is “347”, and the data D273 after detection of the data sync byte is transferred to the address “347” on the SRAM 6. When the data D274 has been transferred, the scale-of-91 counter 211 counts up from “0” to “1” (FIG. 9(e)). The frame binary counter 212 holds “1” (FIG. 9(f)) as no carry signal S107 is supplied from the scale-of-91 counter 211, and the page binary counter 213 holds “1” (FIG. 9(g)) as no carry signal S105 is supplied from the frame binary counter 212. Since the count S101 of the scale-of-91 counter 211, the count S102 of the frame binary counter 212, and the count S103 of the page binary counter 213 are “1”, “1”, and “1”, respectively, the demodulated data transfer SRAM address S106 (FIG. 9(j)) outputted from the adder 217 is “348”, and the data D274 that follows the data D274 is transferred to the SRAM address “348”. Thereafter, the subsequent data D275, . . . are transferred to the SRAM address “349”, . . . , respectively.

The data transfer apparatus according to the embodiment of the present invention operates as described with respect to FIGS. 8 and 9, whereby the data D0˜D363 outputted from the data demodulation circuit 4 are transferred to the specified addresses (FIG. 5(c)) on the SRAM 6.

When the data D0˜D363 from the data demodulation circuit 4 have been transferred, the data sync byte is detected, the scale-of-91 counter 211 counts up from “91” to “0”, the frame binary counter 212 counts up from “1” to “0”, and the page binary counter 213 counts up from “1” to “0”. Thereby, the data transfer returns to the initial state, and the next data D364 is transferred to the SRAM address “0”. Thereafter, the subsequent data are sequentially transferred to the SRAM in the same manner as described above.

[C. Error Correction]

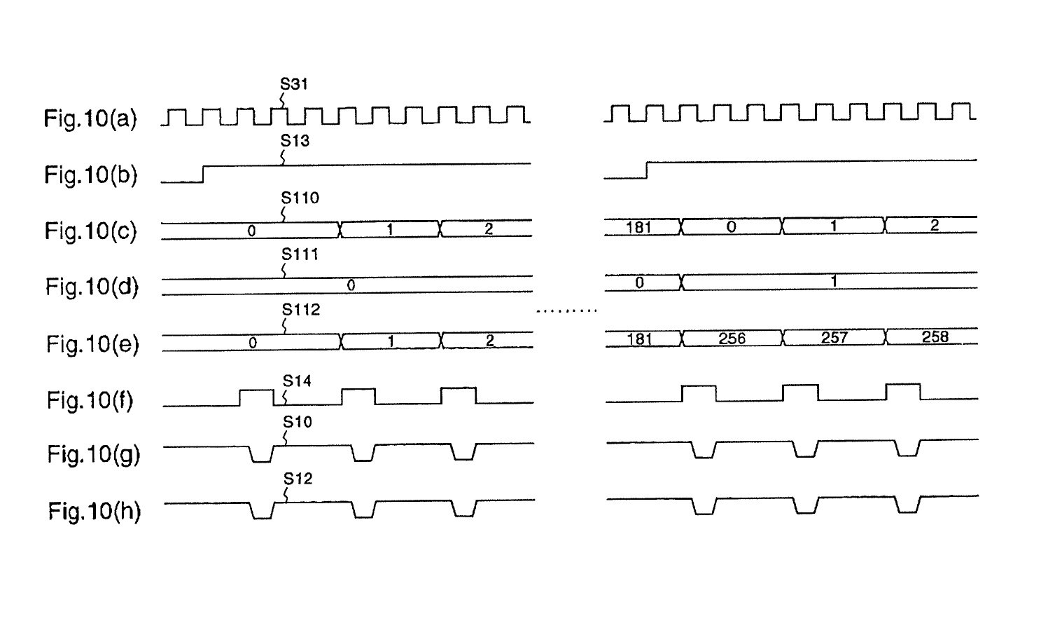

Hereinafter, the operations of the respective signals for data transfer from the SRAM 6 to the error correction circuit 10 will be described with reference to FIG. 10.

FIG. 10 is a diagram for explaining data transfer from the SRAM 6 to the error correction circuit 10.

FIG. 10(a) shows the timing of an operating clock $31 of the error correction circuit 10, and FIG. 10(b) shows the timing of an error correction data transfer request signal S13 to be outputted from the error correction circuit 10 to the SRAM 6. The error correction circuit 10 continues to output the error correction data transfer request signal S13 until 182 bytes of data are transferred because one error correction unit is 182 bytes as shown in FIG. 5(b).

FIG. 10(c) shows the timing of the count S110 of the scale-of-182 counter 221 included in the error correction circuit/data transfer unit 202.

FIG. 10(d) shows the timing of the count S111 of the binary counter 222 included in the error correction circuit/data transfer unit 202, and FIG. 10(e) shows the timing of the error correction data transfer SRAM address S112 that is an address signal to be transferred from the error correction circuit/data transfer unit 202 to the SRAM 6.

On receipt of a signal indicating that data transfer of 182 bytes from the data demodulation circuit 4 to the SRAM 6 has completed, the error correction circuit 10 outputs an error correction data transfer request signal S13 to the SRAM access arbitration circuit 103, for data transfer of the 182 bytes of data (D0˜D181) on the SRAM 6. At this point of time, the scale-of-182 counter 221 and the binary counter 222 in the error correction circuit/data transfer unit 202 are initialized, and the count S110 of the scale-of-182 counter 221 and the count S111 of the binary counter 222 are “0”, and the output of the adder 224 which generates an address signal for access to the SRAM 6 (i.e., an error correction data transfer SRAM address S112) is “0”. The SRAM access arbitration circuit 103 arbitrates access to the SRAM 6 according to the error correction data transfer request signal S13 from the error correction circuit 10, and outputs an error correction data transfer request response signal S14 (FIG. 10(f)) when access is possible. On receipt of the error correction data transfer request response signal S14 (FIG. 10(f)), the timing generation circuit 220 included in the error correction circuit/data transfer unit 202 generates and outputs a chip select signal S10 and a read enable signal S12 for access to the SRAM 6. Since the error correction data transfer SRAM address S112 is “0”, the data D0 (FIG. 5(c)) stored in the address “0” of the SRAM 6 is read and transferred to the error correction circuit 10. Next, on receipt of the error correction data transfer request response signal S14 (FIG. 10(f)), the scale-of-182 counter 221 counts up from “0” to “1”. As the count of the scale-of-182 counter 221 becomes “1”, the address signal S112 becomes “1”, and the data D1 (FIG. 5(c)) stored in the address “1” of the SRAM 6 is read and transferred to the error correction circuit 10. Thereafter, data transfer of 182 bytes (D0˜D181) is sequentially carried out for D2, D3, . . . , D181, as the scale-of-182 counter 221 counts up on receipt of the error correction data transfer request response signal S14 (FIG. 10(f)).

When the data transfer of 182 bytes (D0˜D181) has been completed, the error correction circuit 10 once disables the error correction data transfer request signal S13. When the data transfer of 182 bytes has been completed and error correction has been executed, the error correction circuit 10 outputs a transfer request signal S13 for data transfer of the next 182 bytes (D182˜D363). As described above, it access to the SRAM 6 is possible, the SRAM access arbitration circuit 103 outputs an error correction data transfer request response signal S14 (FIG. 10(f)). On receipt of the error correction data transfer request response signal S14 (FIG. 10(f)), the scale-of-182 counter 221 counts up from “181” at transfer of D181 to “0” (FIG. 10(c)), and outputs a carry signal S114. On receipt of the carry signal S114, the count S111 of the binary counter 222 changes from “0” to “1” (FIG. 10(d)). Since the count S110 of the scale-of-182 counter 221 is “0” and the count Sill of the binary counter 222 is “1”, the X256 value S115 outputted from the X256 multiplier 223 is “256”, and the SRAM address signal S112, that is the sum of the count S110 of the scale-of-182 counter 221 and the X256 value S115, indicates the SRAM address of “256”, whereby the data D182 (FIG. 5(c)) stored at the address “256” of the SRAM 6 is read out. Next, on receipt of the error correction data transfer request response signal S14 (FIG. 10(f)), the scale-of-182 counter 221 counts up from “0” to “1”. When the count S110 of the scale-of-182 counter 221 becomes “1”, the address signal S112 becomes “257”, whereby the data D183 (FIG. 5(c)) stored in the address “257” of the SRAM 6 is read and transferred to the error correction circuit 10. Thereafter, the data transfer of 182 bytes (D182˜D363) is sequentially carried out for D183, D184, . . . , D363, as the scale-of-182 counter 221 counts up on receipt of the error correction data transfer request response signal S14 (FIG. 10(f)).

When the data D182˜D363 have been transferred to the error correction circuit 10 and a data transfer request for the next 182 bytes is made, the scale-of-182 counter 221 counts up from “181” to “0”, and the binary counter 222 counts up from “1” to “0”. Thereby, the data transfer returns to the initial state, and the next data D364 is read from the SRAM address “0”. At this point of time, the data D364 from the data demodulation circuit 4 is transferred to the SRAM 6, and the error correction circuit 10 can read the D364 by accessing the SRAM 6.

Further, data transfer from the error correction circuit 10 to the SRAM 6 is carried out in the same manner as described above.

[D. Data Transfer from SRAM to DRAM]

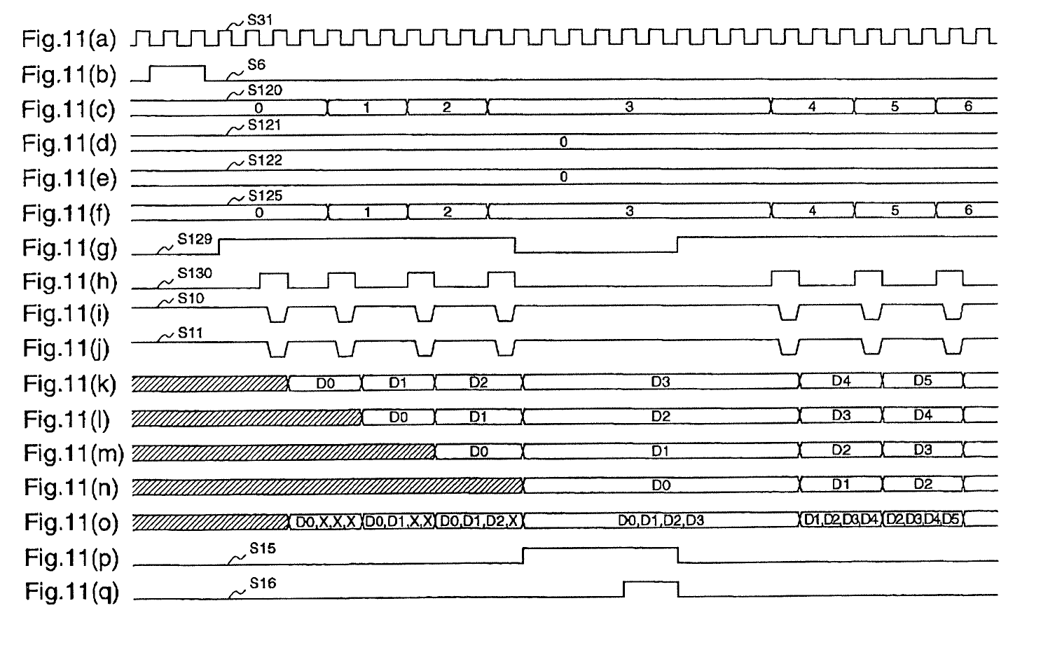

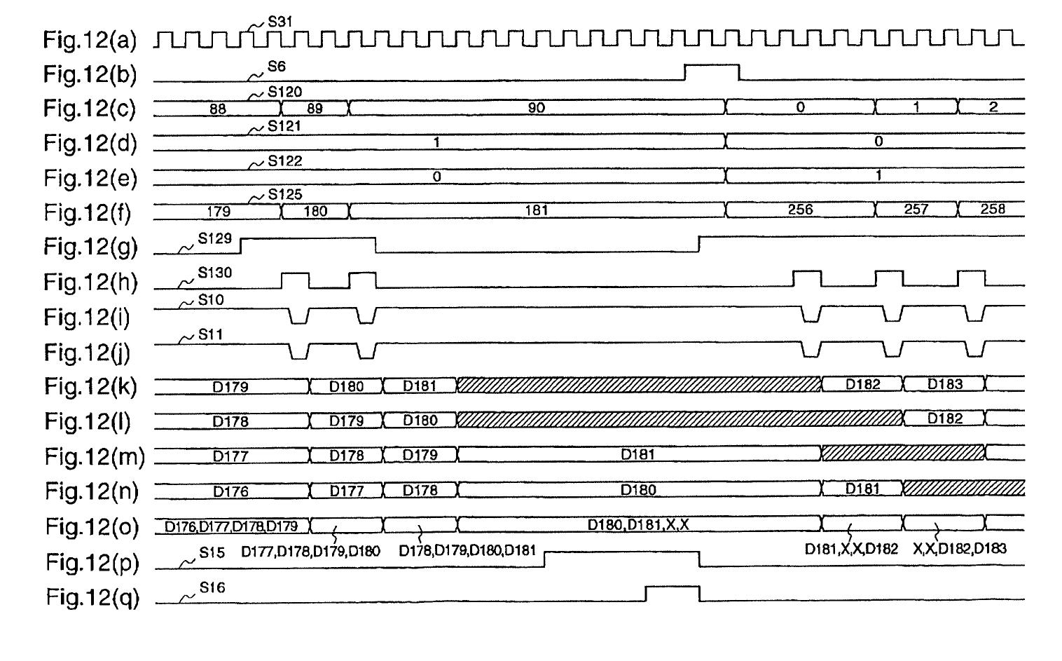

Hereinafter, the operations of the respective signals when transferring the data stored in the SRAM 6 to the DRAM 9 will be described with reference to FIGS. 11 and 12.

FIGS. 11 and 12 are diagrams for explaining data transfer from the SRAM 6 to the DRAM 9.

FIG. 11(a) (FIG. 12(a)) shows a system clock S31 of the DRAM transfer control circuit 102, the DRAM access arbitration circuit 7, the DRAM control circuit 8, and the DRAM 9.

FIG. 11(b) (FIG. 12(b)) shows a data sync byte detection signal S6 from the data demodulation circuit 4.

FIG. 11(c) (FIG. 12(c)) shows the timing of the count s120 of the scale-of-91 counter 304.

FIG. 11(d) (FIG. 12(d)) shows the timing of the count S121 of the frame binary counter 305.

FIG. 11(e) (FIG. 12(e)) shows the count S122 of the page binary counter 306.

FIG. 11(f) (FIG. 12(f)) shows the DRAM data transfer SRAM address S125 that is the sum outputted from the adder 310.

FIG. 11(g) (FIG. 12(g)) shows the SRAM access request signal S129 to the SRAM access arbitration circuit 103, and FIG. 11(h) (FIG. 12(h)) shows the SRAM access request response signal S130 from the SRAM access arbitration circuit 103.

FIG. 11(i) (FIG. 12(i)) shows the timing of the chip select signal S10 to the SRAM 6, and FIG. 11(j) (FIG. 12(j)) shows the operation timing of the read enable signal S12 to the SRAM 6.

FIGS. 11(k),(l),(m),(n) (FIGS. 12(k),(l),(m),(n)) show transition of data in the 4-byte shift register 303.

FIG. 11(o) (FIG. 12(o)) shows the output signal from the 4-byte shift register 303, and this 4-byte shift register output signal is write data to the DRAM 9.

FIG. 11(p) (FIG. 12(p)) shows a DRAM access request signal S15 to be outputted when the data of the output signal from the 4-byte shift register 303 can be transferred to the DRAM 9.

FIG. 11(q) (FIG. 12(q)) shows a DRAM access request response signal S16 that is outputted when the DRAM access arbitration circuit 7 permits access to the DRAM on receipt of the DRAM access request signal S15.

First of all, data transfer for one data processing unit of 182 bytes will be described with reference to FIG. 11. When reading the data stored at the address “0” of the SRAM 6, the scale-of-91 counter 304, the frame binary counter 305, and the page binary counter 306 respectively indicate “0” as initial values (FIGS. 11(c),(d),(e)). Since the count S120 of the scale-of-91 counter 304, the count S121 of the frame binary counter 305, and the count S122 of the page binary counter 306 are “0” as mentioned above, the DRAM data transfer SRAM address S125 outputted from the adder 310 is “0” (FIG. 11(f)). When data transfer to the SRAM 6 is started, a SRAM access request signal S129 is outputted to the SRAM 6 (FIG. 11(g)). On receipt of the SRAM access request signal S129, the SRAM access arbitration circuit 103 outputs a SRAM access request response signal S130 to the DRAM transfer control unit 102 when access to the SRAM 6 is possible (FIG. 11(h)). The timing generation circuit 302 in the DRAM transfer control unit 102 outputs a chip select signal S10 (FIG. 11(i)) and a read enable signal S12 (FIG. 11(j)) to the SRAM 6, and starts data reading from the SRAM 6. At this time, since the DRAM data transfer SRAM address S125 (FIG. 11(f)) is “0” as mentioned above, the data D0 stored at the address “0” in the SRAM 6 can be read out. When the data D0 has been read, the data is stored in the 4-byte shift register 303 (FIG. 11(k)). Further, when the data D0 has been read, the count S120 of the scale-of-91 counter 304 becomes “1”. As the result, the DRAM data transfer SRAM address S125 outputted from the adder 310 indicates “1”, and the data D1 stored in the address “1” of the SRAM 6 can be read out. Thereafter, the scale-of-91 counter 304 successively counts up, and its count S120 changes from “1” to “2”, “3”, whereby the data D2, D3 stored in the SRAM addresses “2”, “3” are successively read out. After the successive reading of the data D1, D2, and D3, the internal registers of the 4-byte shift register 303 successively shift as shown in FIGS. 11(k),(l),(m), and (n), and the data outputted from the 4-byte shift register 303 changes as shown in FIG. 11(o). When the data D0, D1, D2, and D3 have been outputted from the 4-byte shift register 303, since these data can be transferred to the DRAM 9, a DRAM transfer request signal S15 is outputted. On receipt of the DRAM transfer request signal S15, the DRAM access arbitration circuit 7 outputs a DRAM transfer request response signal S16 when access to the DRAM 9 is possible, thereby permitting access to the DRAM 9, and performs 4-byte-unit data transfer of D0, D1, D2, and D3 which are stored in the 4-byte shift register 303. Further, the transfer request signal S129 to the SRAM 6 is once disabled when the 4 bytes of data are stored in the 4-byte shift register 303, and when the 4-byte of data have been transferred to the DRAM 9, the transfer request signal S129 is outputted to resume access to the SRAM 6. Thereafter, in like manner as mentioned above, the next 4 bytes of data D4, D5, D6, D7, the next 4 bytes of data D8, D9, D10, D11, . . . are transferred to the DRAM 9. In this way, the data on the SRAM 6 in units of 1 byte can be transferred to the DRAM 9 in units of 4 bytes, whereby the bus width of the DRAM 9 can be used efficiently.

Next, data transfer of the last two data D180 and D181 in the data processing unit of D0˜D181 will be described with respect to data transfer from the SRAM 6 to the DRAM 9, by referring to FIG. 12. As shown in FIG. 11, when 182 bytes of data are transferred 4 bytes by 4 bytes, the last two bytes (the remainder of 182/4) cannot be transferred because a unit of 4 bytes is not made In this embodiment of the invention, the count S121 of the frame binary counter 305 and the count S120 of the scale-of-91 counter 304 are checked with respect to the 4-byte shift register 303, and when the last two bytes of data D180 and D181 are inputted, two bytes of dummy data are generated in the 4-byte shift register 303 to make a unit of 4 bytes to be transferred (FIGS. 12(k),(l),(m),(n)). In this way, even when one data processing unit cannot be divided by the transfer width without a remainder, data transfer can be performed. When the data up to D181 have been transferred, the count of the frame binary counter 305 changes from “1” to “0”, a carry signal S127 is outputted, the count of the page binary counter 306 changes from “0” to “1”, and the count is multiplied by 256 in the X256 multiplier 308, whereby the DRAM data transfer SRAM address S125 becomes “256”. Therefore, the data D182 stored in the SRAM address “256” can be read out (FIGS. 12(c),(d),(e),(f)).

As described above, since the data transfer apparatus according to the present invention is provided with the SRAM control unit 100 and the SRAM 6, asynchronous clock passing between the reading sync clock S3 according to data reading from the data disk 1 and the system clock S31 of the DRAM access arbitration circuit 7, the DRAM control circuit 8, and the DRAM 9 can be carried out through the SRAM 6 without reducing the cycle of the system clock S31.

Further, 1-byte unit data transfer from the data demodulation circuit 4 can be converted to 4-byte unit data transfer to the DRAM 9, whereby speed-up of DRAM access is achieved. Moreover, since the error correction circuit 10 accesses the SRAM 6, the number of accesses to the DRAM 9 is reduced, whereby the performance is improved without increasing the system clock frequency.

In the above-described operation of the data transfer apparatus, it is premised that there is no missing data in the data outputted from the data demodulation circuit 4. That is, as shown in FIG. 5(a), data are sequentially inputted to the data demodulation circuit 4 with a set of one data sync byte and 91 bytes as a unit.

However, it may well be that some data are lost during data reading or transfer for any reason, and thereby 91 bytes of data cannot be normally inputted. The conventional data transfer circuit deals with loss of data by detecting the amount of missing data in the FIFO buffer 5, and performing interpolation to generate and insert dummy data. In contrast with the conventional apparatus, the data transfer apparatus according to the embodiment of the invention does not take such steps in the FIFO buffer 5 but deals with loss of data when storing the data with missing data to the SRAM 6. To be specific, when the input data are transferred to and stored in the SRAM 6, the positions in the SRAM 6 where the data following the data sync byte should originally be stored are obtained using the data sync byte included in the input data. Therefore, even when there are missing data in the input data, the data that follow the missing data are stored in the same positions in the SRAM 6 as the storage positions when there occurs no loss of data.

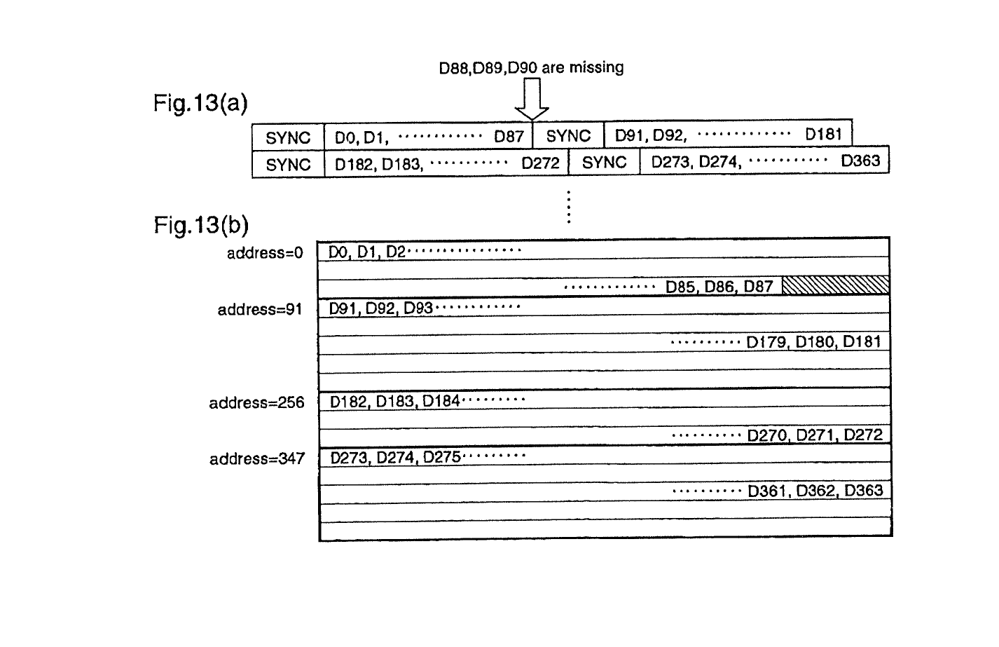

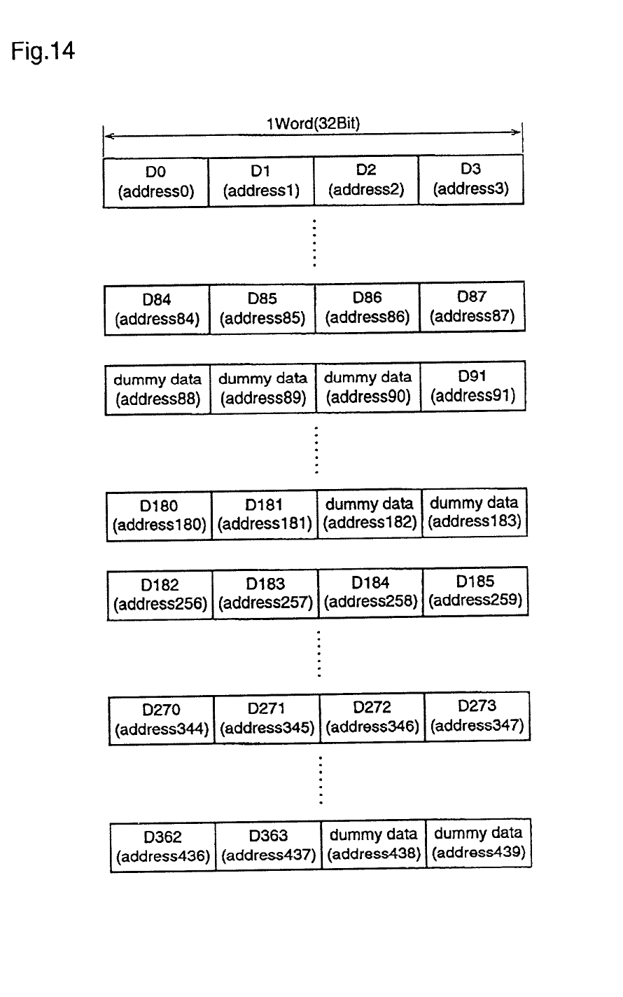

It is now assumed that, as shown in FIG. 13(a), three bytes of data are lost from 91 bytes of data between the first data sync byte and the next data sync byte and, therefore, there are only 88 bytes of data between the data sync bytes. In this case, as shown in FIG. 3(b), data storage into the SRAM 6 is carried out skipping the missing 3 bytes of data, and the data following the detected data sync byte are stored in the original address positions in the SRAM 6. As shown in FIG. 14, when transferring the data from the SRAM 6 to the DRAM 9, dummy data on the SRAM 6 are transferred instead of the missing data, whereby the original data positions are secured.

Hereinafter, a description will be given of the operation of the data transfer apparatus to realize the above-mentioned data transfer.

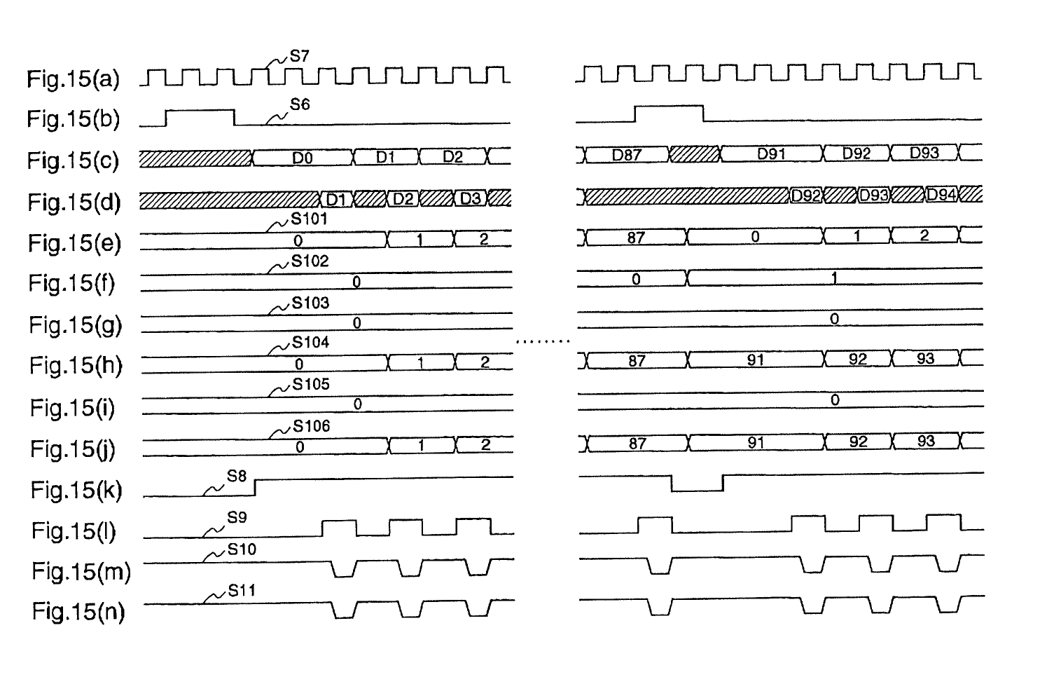

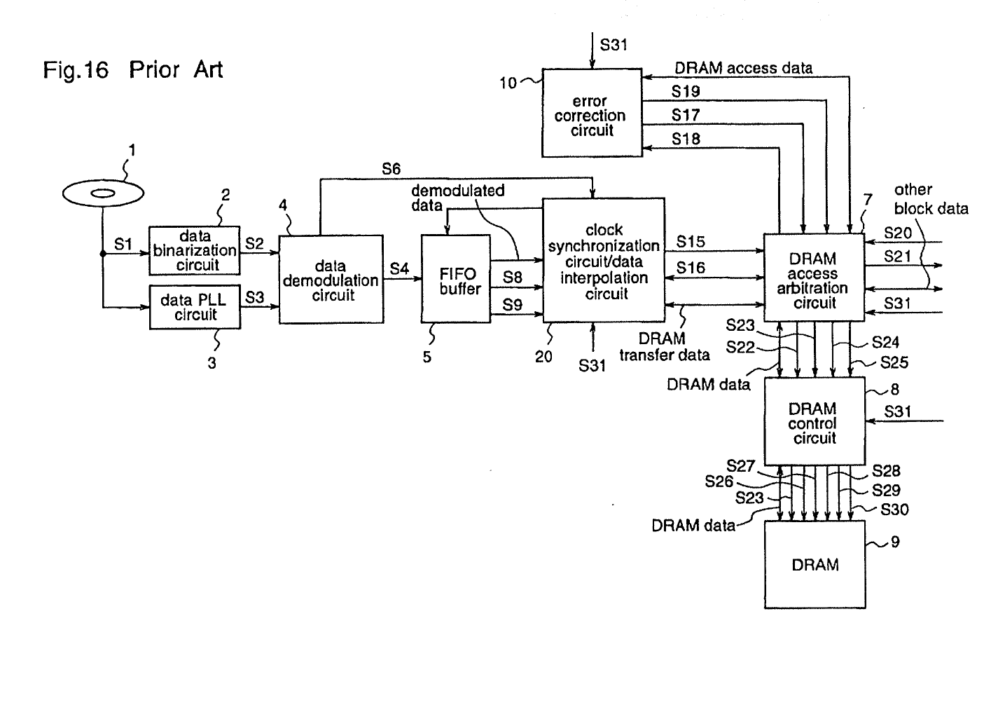

FIG. 15 is a timing chart for explaining data transfer from the FIFO buffer 5 to the SRAM 6. To be specific, FIG. 15(a) shows a transfer clock S7 outputted from the data demodulation circuit 4, and this transfer clock S7 is of the same phase as the demodulation clock S5 used for data transfer from the data modulation circuit 4 to the FIFO buffer 5; but the cycle of the transfer clock S7 is shorter than that of the demodulation clock S5. In this embodiment of the invention, the cycle of the transfer clock S7 is half the cycle of the demodulation clock S8. However, the cycle of the transfer clock S7 may be shorter or longer than half the cycle of the demodulation clock S5 so long as these clocks S7 and S5 are of the same phase, and the cycle depends on the performance of the apparatus.

FIG. 15(b) shows a data sync byte detection signal S6 and, as described above, this signal S6 is outputted when the data demodulation circuit 4 detects a data sync byte from the binary digital signal S2.

FIGS. 15(c) and (d) show part of the internal buffer state of the FIFO buffer 5, and FIG. 15(c) shows the buffer state of the first-stage buffer according to FIFO (first-in first-out) basis while FIG. 15(d) shows the buffer stage of the second-stage buffer.

FIGS. 15(e),(f),(g),(h),(i), and (j) show the respective internal signals of the demodulation circuit/data transfer unit 201.

FIG. 15(k) shows a demodulated data transfer request signal S8 from the FIFO buffer 5 to the SRAM 6, and this signal S8 is outputted to the SRAM control unit 100 when the demodulated data are buffered in the FIFO buffer 5.

FIG. 15(l) shows a demodulated data transfer request response signal S9. When the SRAM access arbitration circuit 103 in the SRAM control unit 100 receives the demodulated data transfer request signal S8 from the FIFO buffer 5, it arbitrates the transfer requests from the error correction circuit 10 and the DRAM transfer control unit 102. As the result of the arbitration, when the arbitration circuit 103 decides that data transfer to the SRAM 6 is possible, it outputs the demodulated data transfer request response signal S9.

FIGS. 15(m) and 15(n) show the chip select signal S10 and the write enable signal S11 for writing data to the SRAM 6, respectively.

As shown in FIG. 15, after the first data sync byte detection signal S6 (FIG. 15(b)) is inputted, the data in the FIFO buffer 5 are sequentially inputted like D0, D1, D2, . . . After the data D87 has been inputted, although the data D88, D89, . . . should follow, the data D88, D89, and D90 are missing. So, the next data sync byte is detected immediately after the data D87 is inputted and, thereafter, the data D91, D92, D93, . . . are sequentially inputted. When the data D87 is inputted, the count of the scale-of-91 counter 211 in the demodulation circuit/data transfer unit 201 indicates “87”, and the counter 211 should count up “88”, “89”, . . . if there is further data input. However, at this point of time, since the data D88, D89, D90 are missing, the data sync byte is detected, whereby the scale-of-91 counter 211 is cleared by the data sync byte detection signal S6, and its count changes from “87” to “0” (FIG. 15(e)). At this time, since the scale-of-91 counter 211 outputs a carry signal S107 to the frame binary counter 212, the count of the frame binary counter 212 changes from “0” to “1” (FIG. 15(f)). Since there is no carry S108 from the frame binary counter 212, the page binary counter 213 holds its count (FIG. 15(g)). As the counts of the respective counters in the demodulation circuit/data transfer unit 201 change as described above, the demodulated data transfer SRAM address signal S106 changes like “87”, “91”, whereby the data D87 is transferred to the address “87” of the SRAM 6, and the following data D91 is transferred to the address “91” of the SRAM 6. In this way, even when there are missing data, since the counter is cleared by the data sync byte detection signal S6, the data following the data sync byte are transferred to their original address positions in the SRAM 6.

As described above, even when there are missing data in the input data, the storage positions on the SRAM 6 after the data sync byte are secured, and data transfer from the SRAM 6 to the error correction circuit 10 or the DRAM 9 is carried out after interpolating the missing data with the dummy data on the SRAM 6. Therefore, the data transfer apparatus of the present invention can deal with loss of data without performing interpolation in the FIFO buffer while the conventional apparatus performs interpolation in the FIFO buffer. Accordingly there is no necessarily to increase the capacity of the FIFO buffer 5 to avoid adverse effects due to a delay in interpolation. In this way, the data transfer apparatus of the present invention can deal with loss of data without increasing the circuit scale and cost.

In the above-described embodiment of the present invention, the format of the input data is constructed such that there are 91 bytes of data between adjacent data sync bytes, and two planes of data units each comprising 182 bytes are stored in the SRAM 6 having the address width of 9 bits, the data width of 8 bits, and the capacity of 4K bits. However, this is merely an example, and the present invention is not restricted to this format but is adaptable to various kinds of input data having different formats. Further, the unit of data storage into the SRAM 6 is not restricted to 2×182 bytes, and any unit may be employed adaptively to the processing using such input data. That is, assuming that the format of input data constructed such that the number of data between adjacent data sync bytes is m, and one data processing unit comprises m×n bytes, when the SRAM 6 has i planes of data storage areas, and data transfer from the SRAM 6 to the DRAM 9 is performed with a data width equivalent to SRAM's data width×j, the same data transfer as described above is achieved by using a scale-of-m counter instead of the scale-of-91 counter, a scale-of-n counter instead of the frame binary counter, a scale-of-m×n counter instead of the scale-of-182 counter, a scale-of-i counter instead of the page binary counter, and a j shift register instead of the 4-byte shift register.

What is claimed is:

1. A data transfer apparatus for transferring sequentially inputted data that have one piece of synchronization data for every m pieces of data and are to be processed in units of data processing each comprising m×n pieces of data, said data transfer apparatus performing synchronization on the successively inputted data by using the synchronization data when performing the data transfer, said apparatus comprising:
data storage means, in which storage positions are specified on the basis of the number of times the synchronization data is transferred, for holding data that are stored in the specified storage positions;
storage address generation means for generating storage addresses indicating the storage positions in the data storage means so that the data are sequentially stored in the specified storage positions in the data storage means when the synchronization data is detected;
storage control means for controlling the data storage into the data storage means, using the storage addresses generated by the storage address generation means;
read address generation means for generating read addresses indicating the storage positions in the data storage means so that the data stored in the data storage means are sequentially read out;
reading control means for controlling the data reading from the data storage means, by using the read addresses generated by the read address generation means;
arbitration means for arbitrating the data storage operation of the storage control means and the data reading operation of the reading control means, in/from the data storage means; and
data conversion means for converting the data read by the reading control means, into predetermined units of data.

2. The data transfer apparatus of claim 1, wherein said storage address generation means comprises:
scale-of-m counting means for counting the sequentially inputted data according to the base m numbering system, which counting means is initialized when the synchronization data is detected;
scale-of-n counting means for counting carries of the scale-of-m counting means, according to the base n numbering system, with the data processing unit comprising m×n pieces of data;
scale-of-i counting means for counting the data according to the base i numbering system, which counting means generates an offset value for every data storage unit so that i pieces of data processing units are stored in the data storage means;
offset value generation means for generating an offset value on the basis of the count value of the scale-of-i counting means; and
storage address generation means for generating the storage addresses indicating the storage positions in the data storage means, on the basis of the count value of the scale-of-m counting means, the count value of the scale-of-n counting means, and the count value of the scale-of-i counting means.

3. The data transfer apparatus of claim 1, wherein said read address generation means comprises:
scale-of-m×n counting means for counting the read data stored in the data storage means, according to the base m×n numbering system;
scale-of-i counting means for counting the data according to the base i numbering system, which counting means generates an offset value for every data storage unit so that i pieces of data processing units stored in the data storage means are read out;
offset value generation means for generating an offset value on the basis of the count value of the scale-of-i counting means; and
read address generation means for generating the read addresses indicating the data reading positions in the data storage means, on the basis of the count value of the scale-of-m ×n counting means, and the count value of the scale-of-i counting means.

4. The data transfer apparatus of claim 1:
wherein said data conversion means converts the data read from the data storage means by the reading control means using the addresses generated by the read address generation means, into predetermined units of data each comprising j pieces of data; and
said data conversion means is provided with data conversion backup means for making up a deficiency of data corresponding to a remainder of m×n/j.

5. A data transfer method for transferring sequentially inputted data that have one piece of synchronization data for every m pieces of data and are to be processed in units of data processing each comprising m×n pieces of data, said data transfer method performing synchronization on the successively inputted data by using the synchronization data when performing the data transfer, said method comprising:
arbitration step of arbitrating the data storage operation of storage control step described later, and the data reading operation of reading control step described later, in/from data storage means, in which storage positions are specified on the basis of the number of times the synchronization data is transferred, for holding data that are stored in the specified storage positions;
storage address generation step of generating storage addresses indicating the storage positions in the data storage means so that the data are sequentially stored in the specified storage positions in the data storage means when the synchronization data is detected;
storage control step of controlling the data storage into the data storage means, using the storage addresses generated in the storage address generation step;
read address generation step of generating read addresses indicating the storage positions in the data storage means so that the data stored in the data storage means are sequentially read out;
reading control step of controlling the data reading from the data storage means, by using the read addresses generated in the read address generation step; and
data conversion step of converting the data read in the reading control step, into predetermined units of data.

6. The data transfer method of claim 5, wherein said storage address generation step comprises:
scale-of-m counting step of counting the sequentially inputted data according to the base m numbering system, which counting step is initialized when the synchronization data is detected;
scale-of-n counting stop of counting carries of the scale-of-m counting step, according to the base n numbering system, with the data processing unit comprising m×n pieces of data;
scale-of-i counting step of counting the data according to the base i numbering system, which counting step generates an offset value for every data storage unit so that i pieces of data processing units are stored in the data storage means;
offset value generation step of generating an offset value on the basis of the count value of the scale-of-i counting step; and
storage address generation step of generating the storage addresses indicating the storage positions in the data storage means, on the basis of the count value of the scale-of-m counting step, the count value of the scale-of-n counting step, and the count value of the scale-of-i counting step.

7. The data transfer method of claim 5, wherein said read address generation step comprises:
scale-of-m×n counting step of counting the read data stored in the data storage means, according to the base m×n numbering system;
scale-of-i counting step of counting the data according to the base i numbering system, which counting step generates an offset value for every data storage unit so that i pieces of data processing units stored in the data storage means are read out;
offset value generation step of generating an offset value on the basis of the count value of the scale-of-i counting step; and
read address generation step of generating the read addresses indicating the data reading positions in the data storage means, on the basis of the count value of the scale-of-m×n counting step, and the count value of the scale-of-i counting step.

8. The data transfer method of claim 5:
wherein said data conversion step converts the data read from the data storage means in the reading control step using the addresses generated in the read address generation step, into predetermined units of data each comprising j pieces of data; and
said data conversion step includes data conversion backup step of making up a deficiency of data corresponding to a remainder of m×n/j.
